(19) United States
(12) Patent Application Publication
(10) Pub. No.: US 2026/0205305 A1
(43) Pub. Date: Jul. 16, 2026

(54) ARTIFICIAL INTELLIGENCE (AI) BASED SYSTEM AND METHOD FOR AUTOMATICALLY GENERATING ONE OR MORE INTELLIGENCE REPORTS FOR USERS

(71) Applicant: Posteros Inc, Marblehead, MA (US)

(72) Inventors: Balaji Chellappa, Cary, NC (US); Robin Priddis, Newton, MA (US); Sayee Natarajan, Wilton, CT (US)

(21) Appl. No.: 19/448,142

(22) Filed: Jan. 14, 2026

Related U.S. Application Data
(60) Provisional application No. 63/744,881, filed on Jan. 14, 2025.

(51) Int. Cl. H04L 9/32; G06N 3/0455

(52) U.S. Cl. CPC H04L 9/3247; G06N 3/0455

(57) ABSTRACT

An AI-based system and method for automatically generating intelligence reports for users, is disclosed. The AI-based system authenticates users through inputs provided by the users, using authentication tokens. The AI-based system classifies intents and entities, to be extracted from received natural language voice commands, using transformer-based model. The AI-based system generates real-time responses for users by retrieving corresponding information from distributed data sources and databases, based on classified intents and extracted entities, using AI model. The AI-based system determines whether data entries associated with interactions of users, are in compliance with regulatory and organizational standards, in real-time, using AI model. The AI-based system stores captured field interaction data with cryptographically secured audit trails, using TDE, TCPS, and ALC. The AI-based system automatically generates the reports/insights comprising field activity reports, compliance summary reports, interaction analytics, and organizational performance dashboards, for roles of users, based on stored field interaction data.

### CROSS-REFERENCE TO RELATED APPLICATIONS

This Application claims priority from a Provisional patent application filed in the United States of America having Patent Application No. 63/744,881, filed on January 14, 2025, and titled “SYSTEM AND METHOD FOR PROVIDING REAL-TIME MULTI-MODAL INSIGHTS TO FIELD OPERATIVES”.

### TECHNICAL FIELD

Embodiments of the present disclosure relate to artificial intelligence (AI) based voice-actuated field operation systems with autonomous compliance enforcement and more particularly to an AI-based system and method for delivering contextually adaptive multi-modal intelligence (i.e., reports/insights) to one or more users (e.g., one or more field operatives) through regulated voice and screen-based interaction workflows with real-time regulatory validation.

### BACKGROUND

Field operatives in regulated industries such as pharmaceuticals and biotechnology face critical operational and compliance challenges in managing field interactions. Conventional field force automation systems require manual data entry through handheld communication devices, resulting in delayed documentation, incomplete interaction records, error-prone data synchronization, and workflow inefficiencies. Existing solutions fundamentally lack integrated real-time compliance verification mechanisms, creating substantial regulatory risks. Field operatives cannot validate whether interactions, data entries, and workflow executions adhere to regulatory frameworks including Food and Drug Administration (FDA) 21 Code of Federal Regulations (CFR) Part 11 guidelines, Health Insurance Portability and Accountability Act (HIPAA) requirements, good practice (GxP) standards, and organizational standard operating procedures during execution. Manual compliance verification occurs post-interaction, leading to non-compliant actions, regulatory violations, failed audits, and compromised data integrity. Furthermore, conventional systems provide inadequate cryptographically secured audit trail generation, limiting traceability and hindering regulatory compliance documentation. The absence of adaptive multi-modal interfaces forces reliance on screen-based workflows during hands-free operational contexts, reducing productivity and increasing documentation errors. Current technological approaches lack architectures integrating autonomous compliance enforcement with adaptive voice and screen-based interaction workflows.

By employing prior systems, the one or more field operatives need to stop activities to log into systems, manually type notes, and search for information, leading to inefficient use of time. The prior systems also struggled with maintaining information accuracy and completeness, as delayed documentation results in forgotten details and incomplete records. Compliance and regulatory adherence are frequently compromised due to missing required fields and compliance elements in the documentation. The one or more field operatives lack real-time access to critical information during interactions. Existing solutions also fail to provide adequate training and performance improvement opportunities, limiting the ability of the one or more field operatives to practice and receive immediate feedback. Additionally, after-hours documentation and the need to balance security with easy system access may cause work-life balance issues and hinder workflow continuity due to frequent context switching between tasks.

Critical deficiencies in existing field force automation systems create urgent need for novel technological solutions addressing regulatory imperatives in pharmaceutical and biotechnology operations. The current systems lack emphasize on data integrity and real-time compliance assurance. Organizations require advanced architectures fundamentally different from conventional retrospective audit approaches. The integration of these capabilities such as autonomous real-time regulatory enforcement, cryptographic audit integrity, and adaptive interface orchestration, which all represents novel technical requirements unmet by existing solutions, establishing fundamental need for innovative architecture advancing regulated pharmaceutical field operations management beyond current technological capabilities.

Hence, there is a need for an improved artificial intelligence based system for the accreditation of industrial professionals and an artificial intelligence based method to operate the same and therefore address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence (AI) based method for automatically generating one or more intelligence reports for one or more users, is disclosed. The AI-based method includes obtaining, by one or more hardware processors, one or more inputs associated with the one or more users, from one or more electronic devices associated with the one or more users. In an embodiment, the one or more inputs comprise at least one of: one or more phone calls through one or more phone numbers, one or more personal identification numbers (PINs), one or more voice biometrics, and one or more organization-assigned credentials, associated with the one or more users.

The AI-based method further includes authenticating, by the one or more hardware processors, the one or more users through the one or more inputs provided by the one or more users, using one or more authentication tokens. The one or more authentication tokens are cryptographically signed using one or more digital signature algorithms for verifying identity verification integrity. The AI-based method further includes receiving, by the one or more hardware processors, one or more natural language voice commands, through at least one of: an automatic speech recognition model and a natural language processing model, from one or more audio capturing units of the one or more electronic devices associated with the one or more users.

The AI-based method further includes classifying, by the one or more hardware processors, one or more intents and one or more entities, to be extracted from the received one or more natural language voice commands, using a transformer-based model. The AI-based method further includes generating, by the one or more hardware processors, one or more real-time responses for the one or more users by retrieving corresponding information from at least one of: one or more distributed data sources and one or more databases, based on the classified one or more intents and the extracted one or more entities, using an AI model. The AI-based method further includes determining, by the one or more hardware processors, whether one or more data entries associated with one or more interactions of the one or more users, are in compliance with one or more regulatory and organizational standards, in real-time, using the AI model.

The AI-based method further includes storing, by the one or more hardware processors, captured field interaction data with one or more cryptographically secured audit trails, using one or more data security mechanism comprising at least one of: transparent data encryption (TDE), transmission control protocol with secure sockets layer and transport layer security (TCPS), and access control lists (ALC). The AI-based method further includes automatically generating, by the one or more hardware processors, the one or more intelligence reports comprising at least one of: one or more field activity reports, one or more compliance summary reports, one or more interaction analytics, and one or more organizational performance dashboards, for one or more roles of the one or more users, based on the stored field interaction data. The AI-based method further includes providing, by the one or more hardware processors, the automatically generated one or more intelligence reports, as an output, to the one or more roles of the one or more users through one or more user interfaces associated with the one or more electronic devices of the one or more users.

In an embodiment, the AI-based method further includes adapting, by the one or more hardware processors, the one or more users for transitions between voice-based workflows and screen-based workflows by: (a) detecting, by the one or more hardware processors, a current interaction modality of the one or more users comprising at least one of: hands-free voice interaction and screen-based interaction; (b) supporting, by the one or more hardware processors, hands-free operation for the voice-based workflows by processing the one or more natural language voice commands through the one or more audio capturing units while the one or more users are on the move; (c) capturing, by the one or more hardware processors, field interaction data through voice dictation during the voice-based workflows; (d) adapting, by the one or more hardware processors, the one or more users to review the logged field interaction data on the one or more user interfaces during the screen-based workflows; (e) adapting, by the one or more hardware processors, the one or more users to edit the logged field interaction data on the one or more user interfaces during the screen-based workflows; (f) adapting, by the one or more hardware processors, the one or more users to refine the logged field interaction data on the one or more user interfaces during the screen-based workflows; (g) determining, by the one or more hardware processors, synchronization between the field interaction data captured through the one or more natural language voice commands and the screen-based workflows by maintaining state consistency across modality transitions; (h) adapting, by the one or more hardware processors, the one or more users to validate the field interaction data before submission through the one or more user interfaces; (i) adapting, by the one or more hardware processors, the one or more users to refine the field interaction data before submission through the one or more user interfaces; (j) adapting, by the one or more hardware processors, the one or more users to finalize the field interaction data before submission through the one or more user interfaces; (k) automatically transferring, by the one or more hardware processors, at least one of: interaction context, captured field interaction data, and workflow progress when switching between the voice-based workflows and the screen-based workflows; (l) adapting, by the one or more hardware processors, a presentation format based on the current interaction modality; and (m) providing, by the one or more hardware processors, the one or more real-time multi-modal insights suited to one or more environments and tasks through appropriate output channels.

In another embodiment, classifying the one or more intents and the one or more entities, to be extracted from the received one or more natural language voice commands, using the transformer-based model, comprises: (a) converting, by the one or more hardware processors, one or more acoustic audio signals from the one or more natural language voice commands into one or more textual transcriptions using the automatic speech recognition model trained on domain-specific terminologies; (b) processing, by the one or more hardware processors, the one or more textual transcriptions through the natural language understanding model employing the transformer-based model; (c) performing, by the one or more hardware processors, intent classification by analyzing semantic meaning of the textual transcriptions through neural network architectures to determine one or more user objectives comprising at least one of: key opinion leader and territory information requests, interaction recording and documentation tasks, calendar and email access queries, and compliance verification inquiries; (d) generating, by the one or more hardware processors, classification confidence scores for the determined one or more user objectives to enable routing decisions on generating the one or more real-time responses; (e) performing, by the one or more hardware processors, entity extraction by identifying one or more key data points associated with one or more entities from the one or more textual transcriptions comprising at least one of: names, dates, locations, product identifiers, and regulatory references using a named entity recognition model; (f) extracting, by the one or more hardware processors, one or more contextual relationships between the extracted one or more entities; and (g) validating, by the one or more hardware processors, the extracted one or more entities against structured data in the one or more databases.

In yet another embodiment, generating the one or more real-time responses, using the AI model, comprises: (a) analyzing, by the one or more hardware processors, the classified one or more intents and the extracted one or more entities, to determine information requirements; (b) identifying, by the one or more hardware processors, relevant data sources from the one or more distributed data sources and the one or more databases, containing the corresponding information, based on the classified one or more intents and the extracted one or more entities; (c) establishing, by the one or more hardware processors, one or more secure connections to the identified relevant data sources through API gateways and data federation protocols; (d) formulating, by the one or more hardware processors, optimized queries tailored to each of the identified relevant data sources using the extracted one or more entities as query parameters; (e) executing, by the one or more hardware processors, the optimized queries across the one or more distributed data sources and the one or more databases in parallel to retrieve the corresponding information; (f) implementing, by the one or more hardware processors, caching mechanisms to store frequently accessed data for accelerated retrieval; (g) consolidating, by the one or more hardware processors, the retrieved corresponding information from multiple data sources into a unified data structure; (h) employing, by the one or more hardware processors, the AI model to synthesize the consolidated information to generate contextually relevant responses that address the classified one or more intents, by analyzing at least one of: relationships, patterns, and contextual relevance; (i) applying, by the one or more hardware processors, query optimization techniques to determine sub-second response times for contextually relevant responses delivery; (j) generating, by the one or more hardware processors, the contextually relevant responses indicating the one or more real-time responses that address the classified one or more intents using natural language generation capabilities of the AI model; (k) personalizing, by the one or more hardware processors, the one or more real-time responses based on historical interaction patterns and user preferences of the one or more users; (l) validating, by the one or more hardware processors, response accuracy and completeness before delivery; and (m) formatting, by the one or more hardware processors, the one or more real-time responses for delivery through at least one of voice-based output and screen-based display according to the current interaction modality.

In yet another embodiment, determining whether the one or more data entries are in compliance with the one or more regulatory and organizational standards comprises: (a) training, by the one or more hardware processors, supervised learning models on historical compliance data comprising compliant interactions and documented violations, to learn one or more patterns of regulatory adherence and non-compliance; (b) extracting, by the one or more hardware processors, one or more features from the one or more data entries comprising at least one of: missing required fields, out-of-sequence workflow steps, unauthorized data access attempts, and temporal anomalies; (c) applying, by the one or more hardware processors, the trained supervised learning models to analyze the extracted features and identify anomalous patterns indicating potential compliance violations in real-time; (d) implementing, by the one or more hardware processors, pre-execution validation gates that evaluate proposed data entries against compliance rule engines before data commit operations; (e) generating, by the one or more hardware processors, compliance risk scores for the one or more data entries using the supervised learning models combined with logic-based rule evaluation; (f) blocking, by the one or more hardware processors, non-compliant data entries that exceed predetermined risk thresholds before data persistence occurs using transaction rollback and access control enforcement mechanisms; (g) continuously monitoring, by the one or more hardware processors, one or more system events through event-driven architecture with stream processing frameworks that analyze the one or more interactions in real-time; (h) detecting, by the one or more hardware processors, compliance deviations by comparing the one or more data entries against regulatory frameworks; (i) flagging, by the one or more hardware processors, detected compliance deviations with configurable alerting thresholds based on severity classification comprising critical, warning, and informational levels; (j) generating, by the one or more hardware processors, informative feedback explaining identified compliance violations and suggesting corrective approaches; and (k) triggering, by the one or more hardware processors, immediate notifications to the one or more users, supervisors, and compliance officers through dashboard visualizations when compliance deviations are detected.

In yet another embodiment, storing the captured field interaction data with the one or more cryptographically secured audit trails comprises: (a) implementing, by the one or more hardware processors, the TDE at a storage level to automatically encrypt the captured field interaction data; (b) generating, by the one or more hardware processors, one or more symmetric encryption keys using advanced encryption standard (AES-256) algorithms for encrypting the captured field interaction data at rest; (c) managing and storing, by the one or more hardware processors, the one or more symmetric encryption keys separately from the encrypted field interaction data through dedicated key management systems with hardware security module protection; (d) implementing, by the one or more hardware processors, key rotation policies to periodically update the one or more symmetric encryption keys for optimized security; (e) enforcing, by the one or more hardware processors, the TCPS encryption using transport layer security protocols for one or more network connections to the one or more databases; (f) rejecting, by the one or more hardware processors, client connection attempts that do not utilize proper secure sockets layer (SSL) certificates with mutual authentication support; (g) implementing, by the one or more hardware processors, the ACL for each client instance that restrict network connectivity based on source IP addresses and classless inter-domain routing (CIDR) blocks; (h) validating, by the one or more hardware processors, that connection requests originate from the one or more electronic devices of the one or more users and enterprise applications within designated network ranges; (i) accommodating, by the one or more hardware processors, the one or more users with one or more locations through dynamic internet protocol (IP) whitelisting using secure virtual private network (VPN) tunnelling gateways that route traffic through validated IP addresses; (j) performing, by the one or more hardware processors, network-level filtering as a first security layer before application-layer authentication comprising voice biometrics and multi-factor authentication; (k) logging, by the one or more hardware processors, one or more ACL enforcement actions, connection attempts, and access denials in the cryptographically secured audit trail; (l) generating, by the one or more hardware processors, cryptographic hash chains using secure hash algorithm (SHA-256) to create tamper-proof audit records for compliance reporting; (m) applying, by the one or more hardware processors, geographic restrictions and micro-segmentation policies to isolate at least one of: database instances, API gateways, and backend services; (n) enforcing, by the one or more hardware processors, principle of least privilege across the distributed system architecture; and (o) tagging, by the one or more hardware processors, each stored record with metadata comprising at least one of: timestamps, field operative identifiers, interaction types, and compliance validation results.

In yet another embodiment, automatically generating the one or more intelligence reports, comprises: (a) retrieving, by the one or more hardware processors, the stored field interaction data from the one or more databases based on predefined reporting criteria; (b) analyzing, by the one or more hardware processors, the stored field interaction data to extract relevant metrics and performance indicators; (c) generating, by the one or more hardware processors, the one or more field activity reports by compiling at least one of: interaction records, visit summaries, and field operative activity logs; (d) generating, by the one or more hardware processors, the one or more compliance summary reports by aggregating compliance verification results, flagged violations, and regulatory adherence metrics; (e) generating, by the one or more hardware processors, the one or more interaction analytics by performing statistical analysis on interaction patterns, engagement frequencies, and outcome measurements; (f) generating, by the one or more hardware processors, the one or more organizational performance dashboards by synthesizing key performance indicators across multiple field operatives and territories; and (g) customizing, by the one or more hardware processors, report content based on the one or more roles of the one or more users using role-based access control mechanisms.

In an aspect, an artificial intelligence (AI) based system for automatically generating one or more intelligence reports for one or more users, is disclosed. The AI-based system includes one or more hardware processors and a memory. The memory is coupled to the one or more hardware processors. The memory comprises a plurality of subsystems in form of programmable instructions executable by the one or more hardware processors. The plurality of subsystems comprises an input receiving subsystem configured to obtain one or more inputs associated with the one or more users, from one or more electronic devices associated with the one or more users. The one or more inputs comprise at least one of: one or more phone calls through one or more phone numbers, one or more personal identification numbers (PINs), one or more voice biometrics, and one or more organization-assigned credentials, associated with the one or more users.

The plurality of subsystems further comprises a user authenticating subsystem configured to authenticate the one or more users through the one or more inputs provided by the one or more users, using one or more authentication tokens. The one or more authentication tokens are cryptographically signed using one or more digital signature algorithms for verifying identity verification integrity. The conversational voice interaction subsystem is further configured to receive one or more natural language voice commands, through at least one of: an automatic speech recognition model and a natural language processing model, from one or more audio capturing units of the one or more electronic devices associated with the one or more users.

The plurality of subsystems further comprises an intent classifying subsystem configured to classify one or more intents and one or more entities, to be extracted from the received one or more natural language voice commands, using a transformer-based model. The plurality of subsystems further comprises a response generating subsystem configured to generate one or more real-time responses for the one or more users by retrieving corresponding information from at least one of: one or more distributed data sources and one or more databases, based on the classified one or more intents and the extracted one or more entities, using an AI model. The plurality of subsystems further comprises a compliance verifying subsystem configured to determine whether one or more data entries associated with one or more interactions of the one or more users, are in compliance with one or more regulatory and organizational standards, in real-time, using the AI model.

The plurality of subsystems further comprises a data logging subsystem configured to store captured field interaction data with one or more cryptographically secured audit trails, using one or more data security mechanism comprising at least one of: transparent data encryption (TDE), transmission control protocol with secure sockets layer and transport layer security (TCPS), and access control lists (ALC). The plurality of subsystems further comprises a report generating subsystem configured to automatically generate the one or more intelligence reports comprising at least one of: one or more field activity reports, one or more compliance summary reports, one or more interaction analytics, and one or more organizational performance dashboards, for one or more roles of the one or more users, based on the stored field interaction data. The plurality of subsystems further comprises an output subsystem configured to provide the automatically generated one or more intelligence reports, as an output, to the one or more roles of the one or more users through one or more user interfaces associated with the one or more electronic devices of the one or more users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is an exemplary block diagram illustrating a network architecture depicting an artificial intelligence (AI) based system for automatically generating one or more intelligence reports/real-time multi-modal insights for one or more users (e.g., one or more field operatives), in accordance with an embodiment of the present disclosure;

FIG. 2 is a detailed view of the AI-based system for automatically generating the one or more intelligence reports/real-time multi-modal insights for the one or more users, in accordance with an embodiment of the present disclosure;

FIG. 3A-3C is an exemplary flow diagram illustrating that the AI-based system is configured with a voice-activated assistant system for medical science liaisons, in accordance with an embodiment of the present disclosure; and

FIG. 4A-4B is a flow diagram illustrating an AI-based method for automatically generating the one or more intelligence reports/real-time multi-modal insights for the one or more users, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises… a" does not, without more constraints, preclude the existence of other devices, sub-systems, additional sub-modules. Appearances of the phrase "in an embodiment”, "in another embodiment" and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client, or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

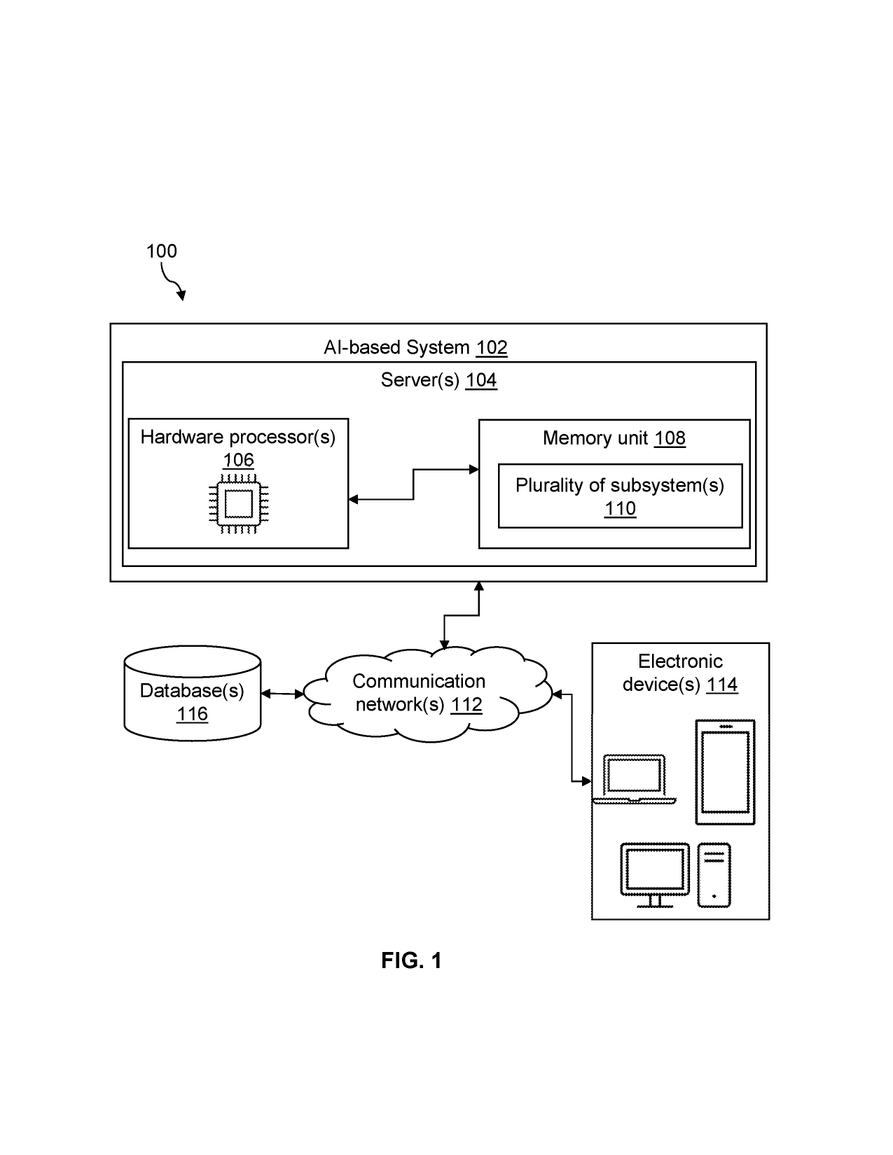

FIG. 1 illustrates an exemplary block diagram representation of a network architecture 100 depicting an artificial intelligence (AI) based system 102 for automatically generating one or more intelligence reports/real-time multi-modal insights for one or more users (e.g., otherwise referred as one or more field operatives), in accordance with an embodiment of the present disclosure, in accordance with an embodiment of the present disclosure.

The disclosed AI-based system 102 comprises one or more hardware processors 106 operatively coupled to a memory unit 108 containing machine-readable instructions. The system architecture implements a distributed computing framework supporting concurrent multi-user access through microservices architecture with load balancing capabilities, ensuring scalability across enterprise deployments in regulated pharmaceutical and biotechnology field operations.

According to an exemplary embodiment of the present disclosure, the network architecture 100 may include the AI-based system 102, one or more databases 116, and one or more electronic devices 114. The AI-based system 102, the one or more databases 116, and the one or more electronic devices 114 may be communicatively coupled via one or more communication networks 112, ensuring seamless data transmission, processing, and decision-making.

The present invention with the AI-based system 102 automatically generates the one or more intelligence reports/real-time multi-modal insights for the one or more users (e.g., the one or more field operatives). The AI-based system 102 is initially configured to obtain one or more inputs associated with the one or more users, from one or more electronic devices 114 associated with the one or more users. The one or more inputs include at least one of: one or more phone calls through one or more phone numbers, one or more personal identification numbers (PINs), one or more voice biometrics, and one or more organization-assigned credentials, associated with the one or more users.

The AI-based system 102 is further configured to authenticate the one or more users through the one or more inputs provided by the one or more users, using one or more authentication tokens. In an embodiment, the one or more authentication tokens are cryptographically signed using one or more digital signature algorithms for verifying identity verification integrity. The AI-based system 102 is further configured to receive one or more natural language voice commands, through at least one of: an automatic speech recognition model and a natural language processing model, from one or more audio capturing units of the one or more electronic devices 114 associated with the one or more users. The AI-based system 102 is further configured to classify one or more intents and one or more entities, to be extracted from the received one or more natural language voice commands, using a transformer-based model.

The AI-based system 102 is further configured to generate one or more real-time responses for the one or more users by retrieving corresponding information from at least one of: one or more distributed data sources and one or more databases 116, based on the classified one or more intents and the extracted one or more entities, using an AI model. The AI-based system 102 is further configured to determine whether one or more data entries associated with one or more interactions of the one or more users, are in compliance with one or more regulatory and organizational standards, in real-time, using the AI model. The AI-based system 102 is further configured to store captured field interaction data with one or more cryptographically secured audit trails, using one or more data security mechanism comprising at least one of: transparent data encryption (TDE), transmission control protocol with secure sockets layer and transport layer security (TCPS), and access control lists (ALC).

The AI-based system 102 is further configured to automatically generate the one or more intelligence reports comprising at least one of: one or more field activity reports, one or more compliance summary reports, one or more interaction analytics, and one or more organizational performance dashboards, for one or more roles of the one or more users, based on the stored field interaction data. The AI-based system 102 is further configured to provide the automatically generated one or more intelligence reports, as an output, to the one or more roles of the one or more users through one or more user interfaces associated with the one or more electronic devices 114 of the one or more users. In an embodiment, the one or more users may include at least one of: the one or more field operatives, one or more healthcare professionals, one or more scientific experts, one or more personnels in one or more organizations, and the like.

The AI-based system 102 acts as a central processing unit within the network architecture 100, responsible for providing the one or more real-time multi-modal insights. The system 102 is configured to execute a set of computer-readable instructions that control a plurality of subsystems 110.

In an exemplary embodiment, the AI-based system 102 comprises one or more servers 104. The one or more servers 104 may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or one or more hardware processors 106.

The one or more servers 104 comprises the one or more hardware processors 106 and a memory unit 108. The memory unit 108 is operatively connected to the one or more hardware processors 106. The memory unit 108 comprises a set of computer-readable instructions in the form of the plurality of subsystems 110, configured to be executed by the one or more hardware processors 106.

In an exemplary embodiment, the one or more hardware processors 106 may include, for example, microprocessors, microcomputers, microcontrollers, digital signal processors, central processing units, state machines, logic circuits, and/or any devices that manipulate data or signals based on operational instructions. Among other capabilities, the one or more hardware processors 106 may fetch and execute computer-readable instructions in the memory unit 108 operationally coupled with the AI-based system 102 for performing tasks such as data processing, input/output processing, and/or any other functions. Any reference to a task in the present disclosure may refer to an operation being or that may be performed on data. The one or more hardware processors 106 are high-performance processors capable of handling large volumes of data and complex computations. The one or more hardware processors 106 may be, but not limited to, at least one of: multi-core central processing units (CPU), graphics processing units (GPUs), and the like that enhance an ability of the AI-based system 102 to process real-time data from one or more sources simultaneously.

In an exemplary embodiment, the one or more databases 116 may configured to store and manage data related to various aspects of the AI-based system 102. The one or more databases 116 may store at least one of, but not limited to, information related to the one or more field operatives, the one or more real-time multi-modal insights, field interaction data, one or more reports, and the like. The one or more databases 116 serve as a centralized repository for critical data elements that are integral to the secure operation of the AI-based system 102, enabling efficient management and synchronization of interactions of the one or more field operatives, compliance data, and the one or more real-time multi-modal insights. The one or more databases 116 enable the AI-based system 102 to dynamically retrieve, analyze, and update the stored data in real-time, for generating and providing the one or more real-time multi-modal insights (e.g., responses to queries/voice commands and intelligence reports) to the one or more field operatives.

The one or more databases 116 may include different types of databases such as, but not limited to, relational databases (e.g., Structured Query Language (SQL) databases such as PostgresDB and Oracle databases^{®}), non-Structured Query Language (NoSQL) databases (e.g., MongoDB, Cassandra), time-series databases (e.g., InfluxDB), an OpenSearch database, object storage systems (e.g., Amazon S3^{®}), and the like. One or more files such as, but not limited to, at least one of: Excel, Comma-Separated Values (CSV), Pipe-Separated Values (PSV), Tab-Separated Values (TSV), JavaScript Object Notation (JSON), and the like are hosted in one of: the object storage systems and a File server/Web server as part of a data source.

In an exemplary embodiment, the one or more electronic devices 114 are configured to enable the one or more field operatives to interact with the AI-based system 102. The one or more electronic devices 114 may be digital devices, computing devices, and/or networks. The one or more electronic devices 114 may include, but not limited to, a mobile device, a smartphone, a personal digital assistant (PDA), a tablet computer, a phablet computer, a wearable computing device, a virtual reality/augmented reality (VR/AR) device, a laptop, a desktop, and the like.

In an exemplary embodiment, the one or more electronic devices 114 may be associated with, but not limited to, one or more service providers, one or more customers, an individual, an administrator, a vendor, a technician, a specialist, an instructor, a supervisor, a team, an entity, an organization, a company, a facility, a bot, any other user, and combination thereof. The entity, the organization, and the facility may include, but not limited to, a hospital, a healthcare facility, an exercise facility, a laboratory facility, a company, a manufacturing unit, an enterprise, an organization, any other facility/organization, and the like.

In an exemplary embodiment, the one or more communication networks 112 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, a combination of networks, and the like. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth^{®}, ZigBee^{®}, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the AI-based system 102 may be implemented by way of a single device or a combination of multiple devices that may be operatively connected or networked together. The AI-based system 102 may be implemented in hardware or a suitable combination of hardware and software.

Though few components and the plurality of subsystems 110 are disclosed in FIG. 1, there may be additional components and subsystems which is not shown, such as, but not limited to, ports, routers, repeaters, firewall devices, network devices, the one or more databases 116, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the AI-based system 102, and the one or more electronic devices 114 connected to the one or more databases 116, one skilled in the art can envision that the AI-based system 102, and the one or more electronic devices 114 may be connected to several user devices located at various locations and several databases via the one or more communication networks 112.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the AI-based system 102 as is unique to the present disclosure or necessary for an understanding of the present disclosure is depicted and described. The remainder of the construction and operation of the AI-based system 102 may conform to any of the various current implementations and practices that were known in the art.

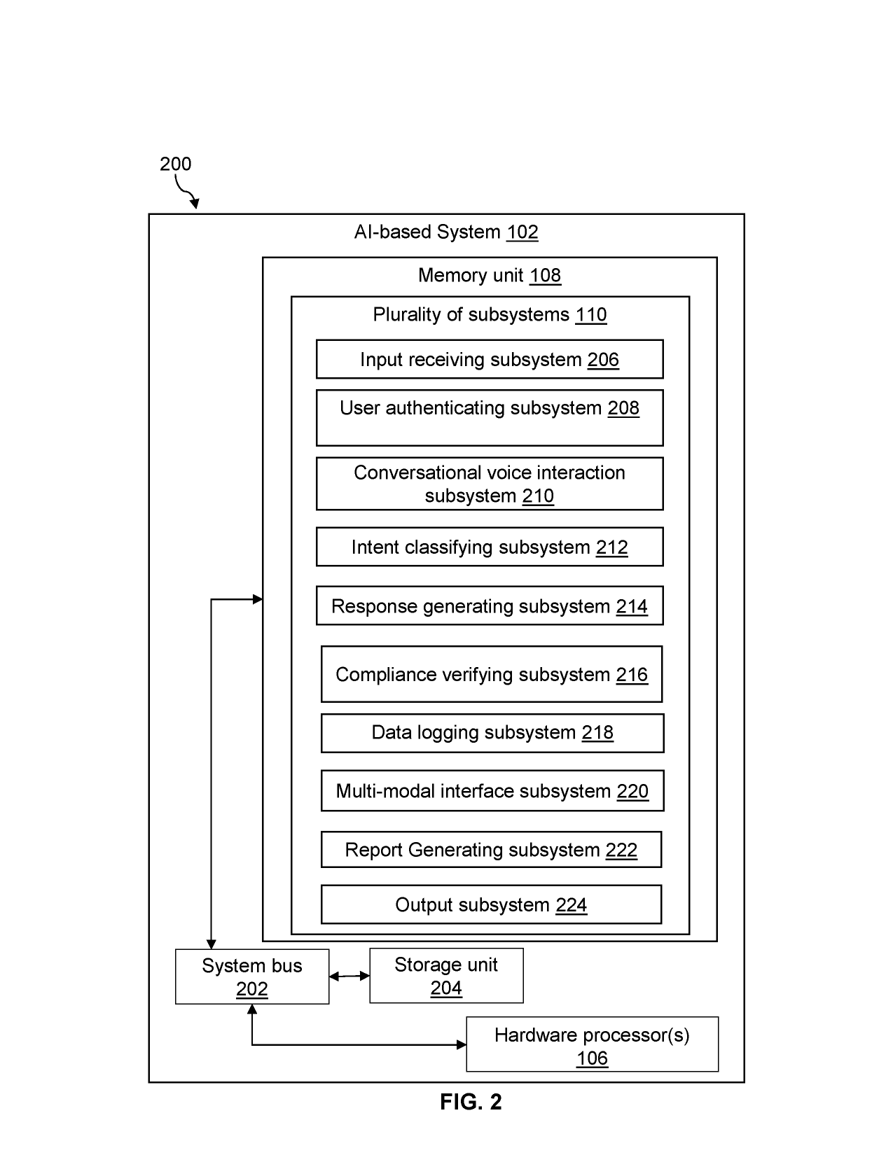

FIG. 2 is a detailed view of the AI-based system 102 for automatically generating the one or more intelligence reports/real-time multi-modal insights for the one or more users, in accordance with an embodiment of the present disclosure; and

In an exemplary embodiment, the AI-based system 102 comprises the one or more servers 104, the memory unit 108, and a storage unit 204. The one or more hardware processors 106, the memory unit 108, and the storage unit 204 are communicatively coupled through a system bus 202 or any similar mechanism. The system bus 202 functions as the central conduit for data transfer and communication between the one or more hardware processors 106, the memory unit 108 (i.e., a memory), and the storage unit 204. The system bus 202 facilitates the efficient exchange of information and instructions, enabling the coordinated operation of the system 102. The system bus 202 may be implemented using various technologies, including but not limited to, parallel buses, serial buses, and high-speed data transfer interfaces such as, but not limited to, at least one of a: universal serial bus (USB), peripheral component interconnect express (PCIe), and similar standards.

In an exemplary embodiment, the memory unit 108 is operatively connected to the one or more hardware processors 106. The memory unit 108 comprises the plurality of subsystems 110 in the form of programmable instructions executable by the one or more hardware processors 106. The plurality of subsystems 110 comprises an input receiving subsystem 206, a user authenticating subsystem 208, a conversational voice interaction subsystem 210, an intent classifying subsystem 212, a response generating subsystem 214, a compliance verifying subsystem 216, a data logging subsystem 218, a multi-modal interface subsystem 220, a report generating subsystem 222, and an output subsystem 224.

The one or more hardware processors 106 associated within the one or more servers 104, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 106 may also include embedded controllers, such as generic or programmable logic devices or arrays, application-specific integrated circuits, single-chip computers, and the like.

The memory unit 108 may be the non-transitory volatile memory and the non-volatile memory. The memory unit 108 may be coupled to communicate with the one or more hardware processors 106, such as being a computer-readable storage medium. The one or more hardware processors 106 may execute machine-readable instructions and/or source code stored in the memory unit 108. A variety of machine-readable instructions may be stored in and accessed from the memory unit 108. The memory unit 108 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 108 includes the plurality of subsystems 110 stored in the form of machine-readable instructions on any of the above-mentioned storage media and may be in communication with and executed by the one or more hardware processors 106.

The storage unit 204 may be a cloud storage or the one or more databases 116 such as those shown in FIG. 1. The storage unit 204 may store, but not limited to, recommended course of action sequences dynamically generated by the system 102. The action sequences comprise field operative registration, conversational voice interaction, data retrieval, compliance verification, interaction logging, multi-modal interface, report generating, and the like. Additionally, the storage unit 204 may retain previous action sequences for comparison and future reference, enabling continuous refinement of the AI-based system 102 over time. The storage unit 204 may be any kind of database such as, but not limited to, relational databases, dedicated databases, dynamic databases, monetized databases, scalable databases, cloud databases, distributed databases, any other databases, and a combination thereof.

The plurality of subsystems 110 includes the input receiving subsystem 206 that is communicatively connected to the one or more hardware processors 106. The input receiving subsystem 206 is configured to obtain the one or more inputs associated with the one or more users, from the one or more electronic devices 114 associated with the one or more users. The one or more inputs comprise at least one of: one or more phone calls through one or more phone numbers, one or more personal identification numbers (PINs), one or more voice biometrics (speaker recognition algorithms including mel-frequency cepstral coefficients and neural voice embeddings), and one or more organization-assigned credentials, associated with the one or more users. As used herein, the input receiving subsystem 206 may refer to a software module or component configured to capture, process, and validate incoming data and commands from users through various input channels. The term "one or more inputs" may refer to data signals, commands, or information provided by users to initiate system interaction and authentication. The term "one or more users" may refer to field operatives, medical science liaisons, pharmaceutical representatives, or other authorized personnel who interact with the system. The term "one or more electronic devices" 114 may refer to computing devices including smartphones, tablets, desktop computers, laptops, or any communication-enabled devices through which users access the AI-based system 102. The term "one or more voice biometrics" may refer to unique vocal characteristics and patterns used for speaker recognition and identity verification. The term "one or more organization-assigned credentials" may refer to authentication information including usernames, passwords, employee identifiers, or access tokens provided by an organization to authorized personnel. The input receiving subsystem 206 may operate by establishing communication interfaces with the one or more electronic devices 114, monitoring for incoming phone calls through telecommunications networks, capturing caller phone numbers through automatic number identification, receiving PIN entries through dual-tone multi-frequency signaling or voice input, collecting voice samples for biometric analysis, accepting organization-assigned credentials through secure input fields, performing initial validation to verify data format and completeness, and routing the validated inputs to downstream authentication subsystems for identity verification.

The plurality of subsystems 110 includes the user authenticating subsystem 208 that is communicatively connected to the one or more hardware processors 106. The user authenticating subsystem 208 is configured to authenticate the one or more users through the one or more inputs provided by the one or more users, using one or more authentication tokens. The one or more authentication tokens are cryptographically signed using one or more digital signature algorithms for verifying identity verification integrity. The user authenticating subsystem 208 is configured to provide secure access to the AI-based system 102 by implementing a multi-layered authentication framework. The field operative registration subsystem 206 employs primary authentication via phone number verification, with optional secondary authentication using at least one of: the voice recognition of the users (i.e., the one or more field operatives) and the PINs for enhanced security. The user authenticating subsystem 208 is configured with one or more role-based access control mechanisms. The one or more role-based access control mechanisms are configured to restrict access to authorized data and functionalities, ensuring that the one or more field operatives interact only with resources relevant to assigned roles within the AI-based system 102. The one or more users/field operatives may access the AI-based system 102 by calling one or more designated phone numbers.

The term one or more authentication tokens may refer to cryptographic data structures containing identity information, access permissions, and validation signatures that serve as proof of successful authentication. The term cryptographically signed may refer to the application of digital signature algorithms to data to ensure authenticity, integrity, and non-repudiation. The term one or more digital signature algorithms may refer to mathematical schemes including RSA (Rivest-Shamir-Adleman), ECDSA (Elliptic Curve Digital Signature Algorithm), or EdDSA (Edwards-curve Digital Signature Algorithm) that create unique signatures verifying data origin and integrity. The term identity verification integrity may refer to the assurance that authentication processes have not been tampered with and that verified identities are genuine and trustworthy. The user authenticating subsystem 208 may operate by receiving the one or more inputs from the input receiving subsystem 206, cross-referencing the received phone number against a database of authorized field operative phone numbers, validating the entered PIN by comparing it against stored encrypted PIN values using secure hash comparison, analyzing voice biometric samples by extracting mel-frequency cepstral coefficients and neural voice embeddings and comparing them against stored voice profiles with probabilistic matching algorithms, verifying organization-assigned credentials against enterprise identity management systems, generating authentication tokens upon successful validation of all authentication factors, applying digital signature algorithms such as RSA-2048 or ECDSA-256 to cryptographically sign the authentication tokens using private keys stored in hardware security modules, embedding user identity information, role assignments, access permissions, and timestamp data within the signed tokens, and transmitting the cryptographically signed authentication tokens to subsequent subsystems to authorize access to system functionalities while logging all authentication attempts with success or failure status in the cryptographically secured audit trail.

The plurality of subsystems 110 includes the conversational voice interaction subsystem 210 that is communicatively connected to the one or more hardware processors 106. The conversational voice interaction subsystem 210 is further configured to receive the one or more natural language voice commands, through at least one of: the automatic speech recognition model and the natural language processing model, from the one or more audio capturing units of the one or more electronic devices 114 associated with the one or more users. As used herein, one or more natural language voice commands may refer to spoken instructions, queries, or statements expressed by users in conversational human language that the system interprets and processes to perform requested actions or retrieve information. The term automatic speech recognition model may refer to a machine learning algorithm or neural network trained to convert acoustic audio signals into textual transcriptions by analyzing sound waves, phonemes, and linguistic patterns. The term natural language processing model may refer to computational algorithms that analyze, understand, and derive meaning from human language in textual or spoken form, enabling machines to interpret user intent and extract relevant information. The term one or more audio capturing units may refer to hardware components including microphones, audio sensors, or sound recording devices integrated into or connected to electronic devices 114 that convert sound waves into electrical signals for digital processing. The conversational voice interaction subsystem 210 may operate by monitoring the one or more audio capturing units for incoming voice input, detecting when a user begins speaking through voice activity detection algorithms, capturing the acoustic audio signals as digital waveforms, transmitting the captured audio data to the automatic speech recognition model which processes the audio through deep neural networks trained on pharmaceutical and medical terminology to generate textual transcriptions, forwarding the textual transcriptions to the natural language processing model which applies transformer-based architectures to parse sentence structure and extract semantic meaning, validating that the transcribed text is coherent and complete, and routing the processed natural language voice commands to the intent classifying subsystem 212 for further analysis while maintaining conversation context and dialogue state across multiple voice interactions. In an embodiment, the NLP models are configured to accurately interpret and respond to one or more user queries that are in the form of the one or more conversational voice commands. The one or more transformer-based models are configured to convert the one or more conversational voice commands into structured outputs for processing. The one or more sequence-to-sequence models are configured to handle the one or more conversational voice commands with sequential context. The conversational voice interaction subsystem 210 is configured to maintain context awareness across conversations, thereby allowing the conversational voice interaction subsystem 210 to maintain a coherent interaction flow across multiple exchanges. The conversational voice interaction subsystem 210 incorporates intelligent error handling, such as asking, clarifying one or more queries when inputs are ambiguous and incomplete.

The plurality of subsystems 110 includes the intent classifying subsystem 212 that is communicatively connected to the one or more hardware processors 106. As used herein, the term intent classifying subsystem 212 may refer to a software module or component that analyzes natural language input to determine user objectives and identify key information elements required to fulfill those objectives. The term one or more intents may refer to the underlying purposes, goals, or objectives that users seek to accomplish through their natural language commands, such as retrieving information, recording interactions, accessing schedules, or verifying compliance. The term one or more entities may refer to specific data elements, objects, or information units mentioned in natural language input including names of people, organizations, products, locations, dates, times, numerical values, and domain-specific identifiers. The term transformer-based model may refer to a neural network architecture utilizing self-attention mechanisms that process sequential data by weighing the importance of different input elements, commonly implemented through architectures such as BERT (Bidirectional Encoder Representations from Transformers), GPT (Generative Pre-trained Transformer), or similar variants that excel at understanding contextual relationships in natural language. The intent classifying subsystem 212 may operate by receiving the textual transcriptions of natural language voice commands from the conversational voice interaction subsystem 210, tokenizing the text into individual words or subword units, converting the tokens into numerical vector representations called embeddings, feeding the embeddings into the transformer-based model which applies multiple layers of self-attention mechanisms to analyze relationships between words and phrases, processing the text through encoder layers that generate contextualized representations capturing semantic meaning, performing intent classification by passing the contextualized representations through a classification head neural network that outputs probability scores for predefined intent categories including Key Opinion Leader information requests, territory information requests, interaction recording tasks, documentation tasks, calendar access queries, email access queries, compliance verification inquiries, adverse event reporting, and product information requests, selecting the intent category with the highest probability score as the classified intent, performing entity extraction by applying named entity recognition algorithms that identify and classify specific data points within the text including person names, organization names, product identifiers, therapeutic area terms, location names, date expressions, time expressions, and regulatory references, extracting contextual relationships between identified entities to understand how they relate to each other within the user's request, validating the extracted entities against structured data in databases to ensure accuracy and resolve ambiguities, generating classification confidence scores indicating the model's certainty in its predictions, and routing the classified intents and extracted entities to the response generating subsystem 214 for information retrieval and response formulation.

The BERT-based model may perform intent classification by processing the input text through its bidirectional encoder layers to generate a pooled output representation from the special [CLS] token prepended to the input sequence, where this [CLS] token aggregates information from the entire input through bidirectional attention, and this pooled representation is then fed into a dense classification layer with softmax activation that maps the high-dimensional embedding to probability scores across predefined intent classes such as territory information request, interaction recording, calendar access, and compliance verification, with the model selecting the intent with the highest probability score as the classified intent. The BERT-based model may perform entity extraction by taking the final hidden state representation for each token in the input sequence and passing these token-level embeddings through a token classification layer that predicts entity labels using the BIO (Begin-Inside-Outside) tagging scheme, where B-PRODUCT indicates the beginning of a product entity, I-PRODUCT indicates continuation of a product entity, B-DATE indicates the beginning of a date entity, and O indicates tokens that are not part of any entity, with the model applying a conditional random field layer on top of the token classifications to ensure valid entity sequences and resolve conflicts where adjacent tokens might have incompatible labels. The BERT model may simultaneously perform both tasks through multi-task learning where the same bidirectional encoder produces contextualized embeddings that feed into two separate output heads, one for sequence-level intent classification using the [CLS] token representation and another for token-level entity extraction using individual token representations, allowing the model to leverage shared linguistic understanding across both tasks while the bidirectional attention mechanism enables each token to incorporate context from both preceding and following words when determining its entity label.

The GPT-based model may perform intent classification by processing the input text through its unidirectional decoder layers and extracting the final hidden state of the last token in the sequence, which has attended to all previous tokens through causal self-attention, and passing this representation through a classification head that outputs intent probabilities, or alternatively by prompting the model with few-shot examples where the model is given several example queries labeled with their intents followed by the new query and a prompt like "The intent of this query is:", causing the model to generate the intent label as natural language text which is then parsed to extract the structured intent category. The GPT-based model may perform entity extraction through a generative approach where the model is prompted to identify and list entities in the input text, for example by appending a prompt such as "Extract all entities from the above query in the format: Product: [product name], Therapeutic Area: [area], Date: [date]" which causes the model to generate structured output listing the identified entities, or through a sequence tagging approach where the model is fine-tuned to generate BIO tags for each input token by treating entity extraction as a sequence-to-sequence generation task where the input sequence is the original text and the output sequence is the corresponding entity labels. The GPT model may leverage its autoregressive generation capability to perform joint intent and entity extraction by generating a structured output that includes both the classified intent and extracted entities in a single generation pass.

For classifying the one or more intents and the one or more entities, to be extracted from the received one or more natural language voice commands, using the transformer-based model, the intent classifying subsystem 212 is configured to: (a) convert one or more acoustic audio signals from the one or more natural language voice commands into one or more textual transcriptions using the automatic speech recognition model trained on domain-specific terminologies; (b) process the one or more textual transcriptions through the natural language understanding model employing the transformer-based model; (c) perform intent classification by analyzing semantic meaning of the textual transcriptions through neural network architectures to determine one or more user objectives comprising at least one of: key opinion leader and territory information requests, interaction recording and documentation tasks, calendar and email access queries, and compliance verification inquiries; (d) generate classification confidence scores for the determined one or more user objectives to enable routing decisions on generating the one or more real-time responses; (e) perform entity extraction by identifying one or more key data points associated with one or more entities from the one or more textual transcriptions comprising at least one of: names, dates, locations, product identifiers, and regulatory references using a named entity recognition model; (f) extract one or more contextual relationships between the extracted one or more entities; and (g) validate the extracted one or more entities against structured data in the one or more databases 116.

A GPT-based model may perform intent classification by processing the input text through its unidirectional decoder layers applying causal self-attention where each token can only attend to previous tokens, extracting the final hidden state of the last token in the sequence which has attended to all previous tokens and encodes the complete input context, passing this representation through a classification head similar to the BERT approach, or employing a few-shot prompting approach where the model is provided with several example queries labeled with their intents followed by the new query and a prompt such as "Based on the above examples, classify the following query into one of these categories: key opinion leader information request, territory information request, interaction recording task, documentation task, calendar access query, email access query, compliance verification inquiry. Query: [input text]. Classification:" causing the model to generate the intent label as natural language text through autoregressive token prediction, parsing the generated text to extract the structured intent category, and leveraging the model's pre-trained knowledge of language patterns and semantic relationships to perform zero-shot or few-shot classification without requiring extensive fine-tuning on labeled intent classification data.

The plurality of subsystems 110 includes the response generating subsystem 214 that is communicatively connected to the one or more hardware processors 106. The response generating subsystem 214 configured to generate the one or more real-time responses for the one or more users by retrieving the corresponding information from at least one of: the one or more distributed data sources and the one or more databases 116, based on the classified one or more intents and the extracted one or more entities, using the AI model.

The response generating subsystem 214 integrates seamlessly with at least one of: the one or more data sources and the one or more databases 116 such as, but not limited to, at least one of: one or more customer relationship management (CRM) systems, one or more medical repositories, one or more appointment schedule systems, one or more email systems (e.g. Outlook^{®} and Gmail^{®}), one or more real-time external data providers (e.g. Weather Application Programming Interface (API) and a FlightTracker), and the like, enabling comprehensive data access. At least one of: the one or more email systems and the one or more real-time external data providers enable dynamic updates for the one or more users (such as one or more Medical Science Liaison (MSL) users), such as weather forecasts and flight status information. By querying at least one of: the one or more email systems and the one or more real-time external data providers, the response generating subsystem 214 provides relevant updates, including daily weather conditions (e.g., rain and snow predictions) and detailed flight information (e.g., departure times, delays and gate numbers).

For instance, If the one or more users frequently travel to meet one or more physicians, the data retrieval subsystem 210 responds to one or more user queries, such as "What time is my flight?" and "Is it going to rain today?" with precise, context-aware information via a voice assistant. The data retrieval subsystem 210 is configured to synthesize the information across at least one of: the one or more data sources and the one or more databases 116 to provide cohesive and meaningful one or more responses to the one or more user queries. Additionally, the data retrieval subsystem 210 performs real-time data retrieval to ensure that the one or more responses reflect the most current and accurate information available.

As used herein, the response generating subsystem 214 may refer to a software module or component configured to formulate, construct, and deliver contextually appropriate answers, information, or actions in response to user requests by retrieving and synthesizing data from multiple sources. The term one or more distributed data sources may refer to multiple separate data repositories, systems, or services that may be geographically dispersed, organizationally distinct, or technologically heterogeneous, including customer relationship management systems, medical information repositories, clinical trial databases, sales analytics platforms, external APIs, cloud storage systems, and real-time data feeds. The term one or more databases may refer to structured data storage systems including relational databases using SQL, NoSQL databases, time-series databases, graph databases, data warehouses, or data lakes that store organizational information in organized, queryable formats. The term classified one or more intents may refer to the categorized user objectives identified through intent classification that represent what the user wants to accomplish. The term extracted one or more entities may refer to specific data elements identified from the user's input that provide parameters, constraints, or context for information retrieval. The term AI model may refer to machine learning algorithms, neural networks, or computational systems trained on data to perform tasks such as natural language understanding, information synthesis, response generation, or decision-making, including transformer-based models like GPT for natural language generation, BERT for semantic understanding, retrieval-augmented generation models that combine information retrieval with language generation, or specialized models for query optimization and response ranking.

The response generating subsystem 214 may operate by receiving the classified intent and extracted entities from the intent classifying subsystem 212, analyzing these inputs to determine what information is needed to fulfill the user's request, identifying relevant data sources from the one or more distributed data sources and the one or more databases 116 that contain the required information by consulting a data source registry or catalog that maps data types to source systems, establishing secure connections to the identified data sources through API gateways that provide authentication, authorization, rate limiting, and protocol translation, or through database connection pools that maintain persistent connections for efficient query execution, formulating optimized queries tailored to each data source by translating the user's intent and entities into source-specific query languages such as SQL for relational databases, MongoDB query language for document databases, Elasticsearch query DSL for search engines, or REST API calls for web services, using the extracted entities as query parameters to filter, constrain, or focus the data retrieval such as using product identifiers in WHERE clauses, date ranges in temporal filters, person names in JOIN conditions, or location entities in geographic filters, executing the queries across multiple data sources in parallel to minimize total response time by using asynchronous processing, thread pools, or distributed computing frameworks, implementing caching mechanisms using in-memory data stores like Redis or Memcached to store frequently accessed data with time-to-live expiration policies, checking the cache before executing queries and storing query results in the cache for subsequent requests, applying query optimization techniques such as index utilization, query plan analysis, result set limiting, pagination, and selective column retrieval to ensure sub-second response times, consolidating retrieved information from multiple data sources into a unified data structure by performing data integration operations such as joining related records, merging duplicate entries, resolving conflicting values, standardizing formats, and organizing data into hierarchical or tabular structures, employing the AI model to synthesize the consolidated information by feeding the retrieved data along with the user's original query into a transformer-based language model such as GPT-3.5, GPT-4, or a domain-adapted variant. The model analyzes relationships between data points, identifies patterns and trends, determines contextual relevance of different information elements, filters out irrelevant details, prioritizes important findings, and generates natural language text that coherently presents the information in a format appropriate for the user's intent, using prompt engineering techniques. The system constructs prompts that include the user's query, the classified intent, the extracted entities, the retrieved data formatted as context, and instructions for how to structure the response, with the AI model processing this prompt through its transformer layers applying self-attention mechanisms to understand relationships between the query and the data, and generating response text token by token through autoregressive prediction where each generated token is conditioned on all previous tokens, applying natural language generation capabilities of the AI model to produce fluent, grammatically correct, contextually appropriate responses that directly address the user's intent, personalizing the responses based on historical interaction patterns and user preferences by incorporating user profile data such as preferred level of detail, communication style, frequently accessed data types, role-specific information needs, and past query history into the prompt or by fine-tuning the AI model on user-specific interaction data, validating response accuracy and completeness before delivery by checking that all required information elements are present, verifying that numerical values fall within expected ranges, confirming that entity references are correctly resolved, and ensuring that the response directly addresses the classified intent, formatting the responses for delivery through voice-based output or screen-based display according to the current interaction modality by generating concise spoken responses with natural prosody for voice output using text-to-speech synthesis, or creating structured visual presentations with tables, charts, bullet points, and hyperlinks for screen-based display, implementing response ranking when multiple potential responses are generated by scoring each candidate response based on relevance, completeness, accuracy, and user preferences, and delivering the highest-ranked response to the user through the appropriate output channel while logging the interaction for audit trail and continuous improvement.

The AI model may employ retrieval-augmented generation architecture where the model first retrieves relevant documents or data records from the databases 116 using semantic similarity search by encoding the user's query into a dense vector representation using a BERT-based encoder, computing cosine similarity between the query vector and pre-computed document vectors stored in a vector database, retrieving the top-k most similar documents, and then feeding these retrieved documents as context into a GPT-based generator that produces the final response by conditioning its generation on both the user's query and the retrieved information, ensuring that the response is grounded in factual data from the databases rather than relying solely on the model's parametric knowledge. The AI model may also employ few-shot learning where the prompt includes several example query-response pairs that demonstrate the desired response format and style, causing the model to generate responses that follow the established pattern, or employ chain-of-thought prompting where the model is instructed to break down complex queries into reasoning steps, retrieve information for each step, and synthesize the results into a comprehensive response.

For generating the one or more real-time responses, using the AI model, the response generating subsystem 214 is configured to: (a) analyze the classified one or more intents and the extracted one or more entities, to determine information requirements; (b) identify relevant data sources from the one or more distributed data sources and the one or more databases 116, containing the corresponding information, based on the classified one or more intents and the extracted one or more entities; (c) establish one or more secure connections to the identified relevant data sources through API gateways and data federation protocols; (d) formulate optimized queries tailored to each of the identified relevant data sources using the extracted one or more entities as query parameters; (e) execute the optimized queries across the one or more distributed data sources and the one or more databases 116 in parallel to retrieve the corresponding information; (f) implement caching mechanisms to store frequently accessed data for accelerated retrieval; (g) consolidate the retrieved corresponding information from multiple data sources into a unified data structure; (h) employ the AI model to synthesize the consolidated information to generate contextually relevant responses that address the classified one or more intents, by analyzing at least one of: relationships, patterns, and contextual relevance; (i) apply query optimization techniques to determine sub-second response times for contextually relevant responses delivery; (j) generate the contextually relevant responses indicating the one or more real-time responses that address the classified one or more intents using natural language generation capabilities of the AI model; (k) personalize the one or more real-time responses based on historical interaction patterns and user preferences of the one or more users; (l) validate response accuracy and completeness before delivery; and (m) format the one or more real-time responses for delivery through at least one of voice-based output and screen-based display according to the current interaction modality.

Employing AI model to synthesize information may refer to the process of using, utilizing, or applying. The term AI model may refer to machine learning algorithms or neural networks such as GPT-4, GPT-3.5, or BERT that can understand and generate natural language.

The AI model may employ a BERT-based architecture to synthesize consolidated information by encoding the retrieved data and the user's query into contextualized embeddings through bidirectional transformer layers, where the model processes both the query tokens and data tokens simultaneously, applying self-attention mechanisms that compute attention weights between all pairs of tokens to identify which data elements are most relevant to which parts of the query, with the attention weights revealing relationships such as high attention between the query term "trial results" and data fields containing efficacy endpoints, between the query term "pembrolizumab" and data records for that specific drug, and between the query term "Northeast territory" and geographic site information, using these attention patterns to determine that efficacy data, drug-specific information, and territory-specific enrollment are the most contextually relevant elements to include in the response, extracting the [CLS] token representation that aggregates information from the entire input through bidirectional attention, passing this representation through task-specific layers that perform relationship extraction to identify connections like "pembrolizumab is studied in KEYNOTE-189 trial" and "KEYNOTE-189 enrolled patients in Northeast territory", pattern recognition to identify that hazard ratio 0.49 represents strong efficacy and that median survival 22.0 months is substantially longer than the comparator 10.7 months, and relevance scoring to rank which data points most directly answer the user's query, and using these analyzed relationships, patterns, and relevance scores to select and organize information for response generation.

The AI model may employ a GPT-based architecture to synthesize consolidated information by constructing a prompt that includes the user's query, the classified intent, and the consolidated data formatted as structured text or JSON, feeding this prompt into the autoregressive transformer model which processes it through multiple decoder layers applying causal self-attention where each token attends to all previous tokens, with the model analyzing relationships by recognizing linguistic patterns in the prompt such as "trial results for pembrolizumab" indicating a drug-outcome relationship, "in non-small cell lung cancer patients" indicating a disease-population relationship, and "in the Northeast territory" indicating a geographic-data relationship, analyzing patterns by identifying that numerical values like "hazard ratio 0.49" and "median OS 22.0 months vs 10.7 months" follow common clinical trial reporting formats and represent efficacy metrics, recognizing that "published January 2024" indicates recent data, and noting that "247 patients enrolled across 15 sites" represents substantial regional participation, analyzing contextual relevance by using its learned knowledge from pre-training on medical literature to understand that hazard ratio below 1.0 indicates benefit, that overall survival is a critical endpoint in oncology trials, and that PD-L1 expression is a relevant biomarker for pembrolizumab, applying this understanding to determine which data elements most directly address the territory information request intent, and generating the response token by token through autoregressive prediction where each generated token is conditioned on the prompt and all previously generated tokens, with the model selecting tokens that form sentences expressing the identified relationships such as "pembrolizumab demonstrated survival benefit", describing the recognized patterns such as "hazard ratio of 0.49 for overall survival", and emphasizing the contextually relevant information such as "in your Northeast territory, this trial enrolled 247 patients across 15 sites."

The AI model may employ a retrieval-augmented generation architecture to synthesize consolidated information by first using a BERT-based encoder to create dense vector representations of the user's query and each piece of consolidated data, computing semantic similarity scores between the query vector and data vectors using cosine similarity or dot product, ranking the data elements by relevance score to identify which information is most contextually relevant, retrieving the top-k most relevant data elements such as the top 5 most similar records, feeding these retrieved elements along with the original query into a GPT-based generator as context, with the generator analyzing relationships by processing the context to understand connections like "the trial studied pembrolizumab" and "the trial enrolled patients in the Northeast territory" through its attention mechanisms that attend strongly to related entities across the context, analyzing patterns by recognizing that the retrieved data contains multiple numerical efficacy metrics following standard clinical trial formats and that these metrics consistently indicate positive outcomes, analyzing contextual relevance by using the relevance scores from the retrieval step to prioritize information, with higher-scored elements receiving more attention weight in the generation process, and generating the response by conditioning each predicted token on both the query and the retrieved relevant context, ensuring the response is grounded in the actual retrieved data rather than the model's parametric knowledge, thereby synthesizing information by combining the retrieval model's ability to identify relevant data with the generation model's ability to produce fluent natural language that expresses relationships, describes patterns, and emphasizes contextually relevant information.

The response generating subsystem 214 is configured to provide the one or more field operatives with real-time one or more insights and decision-making capabilities. The response generating subsystem 214 is configured to generate the one or more responses tailored to historical interaction patterns and field operative preferences, such as recommending follow-ups with specific contacts. The response generating subsystem 214 provides context-aware suggestions during real-time interactions, ensuring relevance and timeliness. By fusing the information from at least one of: the one or more databases 116 and the one or more data sources, the response generating subsystem 214 delivers comprehensive real-time one or more insights, enabling the one or more field operatives to make informed decisions efficiently.

The plurality of subsystems 110 includes the compliance verifying subsystem 216 that is communicatively connected to the one or more hardware processors 106. The compliance verifying subsystem 216 is configured to determine whether one or more data entries associated with one or more interactions of the one or more users, are in compliance with one or more regulatory and organizational standards, in real-time, using the AI model. The one or more regulatory and organizational standards may refer to legal requirements, industry regulations, company policies, and procedural guidelines including FDA 21 CFR Part 11 electronic records requirements, HIPAA privacy and security regulations, Good Clinical Practice guidelines, Good Manufacturing Practice standards, pharmacovigilance requirements, and organization-specific standard operating procedures. The AI model may refer to employing machine learning algorithms, neural networks, or computational systems to perform compliance analysis and validation. The compliance verifying subsystem 216 may determine whether data entries are in compliance by receiving data entry information from users as they document interactions, extracting features from the data entries including field completeness, data formats, temporal sequences, content patterns, and semantic meaning, feeding these features into supervised learning models such as random forests, gradient boosting machines, or neural networks that have been trained on historical compliance data containing examples of both compliant and non-compliant interactions, with the models learning patterns that distinguish compliant entries such as complete required fields, proper temporal ordering, appropriate content, and absence of prohibited information from non-compliant entries such as missing required fields, out-of-sequence workflow steps, unauthorized data access, mentions of off-label use without proper documentation, or delayed adverse event reporting, applying these trained models to analyze the current data entry in real-time and generate a compliance risk score indicating the probability that the entry violates regulatory or organizational standards, comparing this risk score against predetermined thresholds to classify the entry as compliant, potentially non-compliant requiring review, or definitively non-compliant requiring blocking, implementing pre-execution validation gates that prevent non-compliant data from being committed to the database by triggering transaction rollback when violations are detected, continuously monitoring system events through event-driven architecture with stream processing frameworks that analyze user actions as they occur, detecting specific compliance deviations such as attempts to access data outside assigned territories, documentation delays exceeding regulatory timeframes, or mentions of adverse events that require expedited reporting, flagging detected deviations with severity classifications of critical, warning, or informational based on the nature and impact of the violation, generating informative feedback messages that explain the specific compliance issue and suggest corrective actions, and triggering immediate notifications to the user, their supervisor, and compliance officers through dashboard alerts, email notifications, or system messages.

The AI model may employ a BERT-based transformer architecture for compliance verification by encoding the text content of data entries into contextualized embeddings through bidirectional transformer layers, where the model has been fine-tuned on a labeled dataset of historical interaction records annotated with compliance labels indicating whether each record met regulatory requirements, with the fine-tuning process adjusting the model's weights to recognize linguistic patterns associated with compliance violations such as phrases indicating off-label promotion like "this drug works great for unapproved condition X", mentions of adverse events like "the patient experienced serious side effects", incomplete documentation patterns like vague descriptions without specific dates or outcomes, or inappropriate content like competitive disparagement, applying multi-head self-attention mechanisms that compute attention weights between all tokens in the data entry to identify suspicious patterns where certain words or phrases attend strongly to compliance-relevant terms, passing the [CLS] token representation that aggregates information from the entire entry through a classification head with softmax activation that outputs probability scores for compliance categories including compliant, missing required fields, adverse event not flagged, off-label discussion, documentation delay, and unauthorized access, selecting the category with highest probability as the predicted compliance status, and generating a compliance risk score from the probability distribution where high probability of violation categories produces high risk scores triggering blocking or alerting mechanisms.

The AI model may alternatively employ a GPT-based transformer architecture for compliance verification by constructing a prompt that includes compliance checking instructions, the regulatory requirements and organizational policies formatted as rules, and the data entry content to be evaluated, feeding this prompt into the autoregressive language model which processes it through decoder layers applying causal self-attention, with the model generating a structured compliance assessment through few-shot learning where the prompt includes several example data entries labeled as compliant or non-compliant with explanations of why, causing the model to generate similar assessments for the new entry by predicting tokens that form sentences like "This entry is non-compliant because it mentions an adverse event (patient experienced severe headache) but does not include the required expedited reporting flag" or "This entry is compliant as it includes all required fields: date, time, attendee name, discussion topics, materials provided, and follow-up actions", parsing this generated text to extract the compliance determination and specific violation types, converting the textual assessment into a structured format with compliance status, risk score, violation categories, and recommended actions, and using this structured output to make enforcement decisions such as blocking the data entry, requiring additional fields, or flagging for review.

The compliance verifying subsystem 216 is configured to at least one of: perform automated checks to validate required fields during data entry, identify missing information, format errors, and the like. The compliance verifying subsystem 216 detects and flags potential compliance issues, such as mentions of adverse events in pharmaceutical contexts. The compliance verifying subsystem 216 provides one or more real-time prompts to guide the one or more field operatives to one of: correct and complete data as needed, thereby maintaining compliance integrity. The one or more prompts are transmitted to a user interface associated with the one or more electronic devices 114. Additionally, the compliance verifying subsystem 216 logs compliance-critical metadata, including timestamps and identification of the one or more field operatives, to create a robust audit trail for regulatory verification and accountability.

For determining whether the one or more data entries are in compliance with the one or more regulatory and organizational standards, the compliance verifying subsystem 216 is configured to: (a) train supervised learning models on historical compliance data comprising compliant interactions and documented violations, to learn one or more patterns of regulatory adherence and non-compliance; (b) extract one or more features from the one or more data entries comprising at least one of: missing required fields, out-of-sequence workflow steps, unauthorized data access attempts, and temporal anomalies; (c) apply the trained supervised learning models to analyze the extracted features and identify anomalous patterns indicating potential compliance violations in real-time; (d) implement pre-execution validation gates that evaluate proposed data entries against compliance rule engines before data commit operations; (e) generating compliance risk scores for the one or more data entries using the supervised learning models combined with logic-based rule evaluation; (f) blocking non-compliant data entries that exceed predetermined risk thresholds before data persistence occurs using transaction rollback and access control enforcement mechanisms; (g) continuously monitoring one or more system events through event-driven architecture with stream processing frameworks that analyze the one or more interactions in real-time; (h) detecting compliance deviations by comparing the one or more data entries against regulatory frameworks; (i) flagging detected compliance deviations with configurable alerting thresholds based on severity classification comprising critical, warning, and informational levels; (j) generating informative feedback explaining identified compliance violations and suggesting corrective approaches; and (k) triggering immediate notifications to the one or more users, supervisors, and compliance officers through dashboard visualizations when compliance deviations are detected.

The random forest model may generate compliance risk scores by receiving the extracted feature vector from a data entry, passing this feature vector through each of the trained decision trees in the forest, with each tree evaluating the features at successive nodes by comparing feature values against learned threshold conditions such as checking if number of filled required fields is less than 10 or if documentation delay hours exceeds 24 or if adverse event keywords count is greater than 2, traversing down the appropriate branch at each node based on whether the condition is true or false, reaching a leaf node at the end of each tree that contains a class label (compliant or non-compliant) and a probability score based on the proportion of training examples at that leaf that belonged to each class, collecting the predictions from all trees where some trees may predict compliant and others may predict non-compliant, computing the final probability of non-compliance as the fraction of trees that voted for non-compliant divided by the total number of trees, using this probability as the machine learning risk score, and outputting this score along with feature importance values that indicate which input features most strongly influenced the prediction.

The gradient boosting model may generate compliance risk scores by receiving the extracted feature vector, initializing a prediction with a base value such as the overall non-compliance rate in the training data, sequentially passing the features through each trained tree in the ensemble, with the first tree making an initial prediction about the compliance risk, the second tree predicting the residual error from the first tree's prediction and adding a weighted correction, the third tree predicting the residual error from the combined predictions of the first two trees and adding another weighted correction, continuing this process through all trees in the ensemble typically 100 to 500 trees, with each tree focusing on the examples that previous trees struggled with by examining the gradient of the loss function with respect to the current predictions, combining all tree predictions through weighted summation where each tree's contribution is scaled by a learning rate parameter typically between 0.01 and 0.3, applying a logistic sigmoid function to the final summed value to convert it into a probability score between 0 and 1, using this probability as the machine learning risk score, and providing feature importance scores calculated by measuring how much each feature contributed to reducing prediction error across all trees.

The logic-based rule evaluation may generate rule-based risk scores by maintaining a repository of explicitly coded compliance rules derived from regulatory requirements, with each rule having a structure such as IF condition THEN violation with associated severity weight, evaluating each rule against the data entry by checking whether the condition is satisfied, for example Rule 1: IF text contains adverse event keywords AND adverse event flag equals false THEN violation equals adverse\_event\_not\_flagged with severity weight 1.0, Rule 2: IF number of filled required fields less than 10 THEN violation equals missing\_required\_fields with severity weight 0.5, Rule 3: IF documentation delay hours greater than 24 AND adverse event flag equals true THEN violation equals documentation\_delay with severity weight 0.8, checking each condition and identifying which rules are violated, summing the severity weights of all violated rules to compute a total rule violation score, normalizing this score by dividing by the maximum possible violation score if all rules were violated, producing a rule-based risk score between 0 and 1, and combining this rule-based score with the machine learning risk score using methods such as weighted average where final risk score equals 0.7 times ML score plus 0.3 times rule score, or maximum function where final risk score equals the higher of ML score or rule score, or additive approach where final risk score equals ML score plus rule score penalty capped at maximum 1.0.

The plurality of subsystems 110 includes the data logging subsystem 218 that is communicatively connected to the one or more hardware processors 106. In an exemplary embodiment, the data logging subsystem 218 is configured to efficiently capture field interaction through voice dictation of the one or more field operatives. The data logging subsystem 218 is configured to organize and store field interaction data. The data logging subsystem 218 is configured to automatically document the interactions of the one or more field operatives, ensuring that no details are overlooked during field activities. Each record is automatically tagged with relevant metadata such as, but not constrained to, at least one of: date, time, location, and the like, to facilitate easy access and context. The logged field interaction data is securely stored in the one or more databases 116, ensuring reliable and scalable storage for future retrieval.

The data logging subsystem 218 may refer to a software module or component configured to capture, organize, store, and manage field interaction data with security protections and audit capabilities. The store may refer to the process of saving, persisting, or recording data in databases or storage systems for long-term retention and retrieval. The captured field interaction data may refer to information about meetings, conversations, or engagements between field operatives and healthcare professionals including details such as date, time, attendee names, discussion topics, materials provided, outcomes, and follow-up actions. The one or more cryptographically secured audit trails may refer to tamper-proof records of all data access, modifications, and system events that use cryptographic techniques such as hash chains or digital signatures to ensure the records cannot be altered without detection. The one or more data security mechanisms may refer to technical controls, protocols, and systems that protect data confidentiality, integrity, and availability. The transparent data encryption (TDE) may refer to a database security feature that automatically encrypts data files at the storage level using symmetric encryption algorithms such as AES-256, with encryption and decryption occurring transparently without requiring application code changes, and with encryption keys managed separately from the encrypted data through dedicated key management systems. The transmission control protocol with secure sockets layer and transport layer security (TCPS) may refer to network communication protocols that encrypt data in transit between clients and servers using SSL/TLS cryptographic protocols, establishing secure encrypted channels that prevent eavesdropping and man-in-the-middle attacks. The access control lists (ACL) may refer to security configurations that specify which users, applications, or network addresses are permitted to access specific resources, restricting database connectivity based on source IP addresses, CIDR blocks, or network ranges to ensure only authorized systems can establish connections.

The data logging subsystem 218 may store captured field interaction data by receiving interaction records from field operatives through the input receiving subsystem 206 after they have been validated by the compliance verifying subsystem 216, organizing the data into structured database tables with defined schemas including fields for interaction metadata, participant information, discussion content, and compliance indicators, implementing TDE at the database storage level by configuring the database management system to automatically encrypt all data files using AES-256 encryption algorithm before writing to disk, generating and managing symmetric encryption keys through a dedicated key management system that stores keys separately from the encrypted data in hardware security modules with access restricted to database administrators, ensuring that even if storage media is physically stolen the data remains unreadable without the encryption keys, implementing TCPS for all network connections to the database by configuring the database server to require SSL/TLS encryption for client connections, rejecting any connection attempts that do not present valid SSL certificates, establishing encrypted communication channels using TLS 1.3 protocol that encrypts all data transmitted between the application servers and database servers preventing network eavesdropping, implementing ACL by configuring network-level access restrictions that specify which IP addresses or CIDR blocks are permitted to connect to the database, validating that connection requests originate from authorized application servers within designated network ranges such as the corporate data center subnet 10.0.0.0/16 or approved VPN gateway addresses, rejecting connection attempts from unauthorized IP addresses before they reach the authentication layer, accommodating field operatives with dynamic IP addresses by routing their connections through secure VPN tunneling gateways that present validated IP addresses to the database, generating cryptographically secured audit trails by creating audit log entries for every data access, modification, or deletion operation that include timestamp, user identity, action type, affected records, and before/after values, applying SHA-256 cryptographic hash functions to create hash chains where each audit log entry includes the hash of the previous entry, making it computationally infeasible to alter historical audit records without detection because any change would break the hash chain, tagging each stored interaction record with metadata including field operative identifier, interaction type, compliance validation results, and data classification labels, and maintaining data retention policies that archive older records to long-term storage while keeping recent records in high-performance databases for quick access.

For storing the captured field interaction data with the one or more cryptographically secured audit trails, the data logging subsystem 218 is configured to: (a) implement the TDE at a storage level to automatically encrypt the captured field interaction data; (b) generate one or more symmetric encryption keys using advanced encryption standard (AES-256) algorithms for encrypting the captured field interaction data at rest; (c) manage and storing the one or more symmetric encryption keys separately from the encrypted field interaction data through dedicated key management systems with hardware security module protection; (d) implement key rotation policies to periodically update the one or more symmetric encryption keys for optimized security; (e) enforce the TCPS encryption using transport layer security protocols for one or more network connections to the one or more databases 116; (f) reject client connection attempts that do not utilize proper secure sockets layer (SSL) certificates with mutual authentication support; (g) implement the ACL for each client instance that restrict network connectivity based on source IP addresses and classless inter-domain routing (CIDR) blocks; (h) validate that connection requests originate from the one or more electronic devices 114 of the one or more users and enterprise applications within designated network ranges; (i) accommodate the one or more users with one or more locations through dynamic internet protocol (IP) whitelisting using secure virtual private network (VPN) tunnelling gateways that route traffic through validated IP addresses; (j) perform network-level filtering as a first security layer before application-layer authentication comprising voice biometrics and multi-factor authentication; (k) log one or more ACL enforcement actions, connection attempts, and access denials in the cryptographically secured audit trail; (l) generate cryptographic hash chains using secure hash algorithm (SHA-256) to create tamper-proof audit records for compliance reporting; (m) apply geographic restrictions and micro-segmentation policies to isolate at least one of: database instances, API gateways, and backend services; (n) enforce principle of least privilege across the distributed system architecture; and (o) tag each stored record with metadata comprising at least one of: timestamps, field operative identifiers, interaction types, and compliance validation results.

The plurality of subsystems 110 includes the multi-modal interface subsystem 220 that is communicatively connected to the one or more hardware processors 106. The multi-modal interface subsystem 220 is configured to adapt the one or more users for transitions between voice-based workflows and screen-based workflows by: (a) detecting a current interaction modality of the one or more users comprising at least one of: hands-free voice interaction and screen-based interaction; (b) supporting hands-free operation for the voice-based workflows by processing the one or more natural language voice commands through the one or more audio capturing units while the one or more users are on the move; (c) capturing field interaction data through voice dictation during the voice-based workflows; (d) adapting the one or more users to review the logged field interaction data on the one or more user interfaces during the screen-based workflows; (e) adapting the one or more users to edit the logged field interaction data on the one or more user interfaces during the screen-based workflows; (f) adapting the one or more users to refine the logged field interaction data on the one or more user interfaces during the screen-based workflows; (g) determining synchronization between the field interaction data captured through the one or more natural language voice commands and the screen-based workflows by maintaining state consistency across modality transitions; (h) adapting the one or more users to validate the field interaction data before submission through the one or more user interfaces; (i) adapting the one or more users to refine the field interaction data before submission through the one or more user interfaces; (j) adapting the one or more users to finalize the field interaction data before submission through the one or more user interfaces; (k) automatically transferring at least one of: interaction context, captured field interaction data, and workflow progress when switching between the voice-based workflows and the screen-based workflows; (l) adapting a presentation format based on the current interaction modality; and (m) providing the one or more real-time multi-modal insights suited to one or more environments and tasks through appropriate output channels.

Adapting the one or more users for transitions between voice-based workflows and screen-based workflows may refer to the process of enabling, facilitating, and configuring the system to support field operatives in seamlessly switching between task sequences completed through spoken voice commands and task sequences completed through visual screen-based interfaces, where the system automatically detects which interaction mode the user is currently employing, preserves all captured data and workflow state across the mode transitions, transfers interaction context and progress when users switch from hands-free voice operation while mobile to detailed screen-based review and editing when stationary, maintains data synchronization ensuring that information entered or modified in one mode is immediately available and consistent in the other mode, and provides appropriate input processing and output formatting optimized for each modality such as concise audio responses for voice mode and detailed visual displays for screen mode, thereby allowing users to fluidly move between voice dictation while driving or walking and screen-based validation and refinement while at their desk without losing context, repeating work, or experiencing data inconsistencies.

The plurality of subsystems 110 further includes the report generating subsystem 222 that is communicatively connected to the one or more hardware processors 106. The report generating subsystem 222 is configured to streamline the generation and sharing of one or more reports for the one or more field operatives. The report generating subsystem 222 is configured to automatically generate the one or more intelligence reports comprising at least one of: the one or more field activity reports, the one or more compliance summary reports, the one or more interaction analytics, and the one or more organizational performance dashboards, for the one or more roles of the one or more users, based on the stored field interaction data. The report generating subsystem 222 automatically generates at least one of: summaries, drafts, and the one or more reports based on the logged field interaction data, ensuring accuracy and saving time. At least one of: the summaries, the drafts, and the one or more reports are displayed on the user interface. The user interface allows the one or more field operatives to review voice-captured information and enables editing and refinement of documented interactions.

Automatically generating the one or more intelligence reports may refer to the process of creating, producing, and compiling without manual intervention various types of structured documents, visualizations, and analytical summaries that include detailed records of field operative activities showing interactions, visits, and engagements, comprehensive summaries of compliance verification results showing adherence to regulatory requirements and identified violations, statistical analyses of interaction patterns showing frequencies, trends, and engagement metrics, and visual dashboard displays showing key performance indicators across territories and teams, where these reports are specifically customized, tailored, and formatted according to the job functions, responsibilities, and information needs of different user categories such as field operatives who need their individual activity summaries, supervisors who need team performance overviews, compliance officers who need violation tracking and audit reports, and executives who need strategic organizational metrics, all generated by retrieving, analyzing, aggregating, and synthesizing the field interaction data that has been captured, validated, and permanently stored in the databases with cryptographic security and audit trails.

The report generating subsystem 222 may automatically generate intelligence reports by retrieving stored field interaction data from the databases 116 based on predefined reporting criteria such as date ranges, territories, users, or compliance status, analyzing the data to extract relevant metrics including interaction counts, compliance scores, coverage statistics, and trend patterns, aggregating data across multiple dimensions such as by field operative, by territory, by product, by time period, or by compliance category, applying role-based filtering to ensure each user role receives only the information they are authorized to access, formatting the analyzed data into appropriate report structures with tables, charts, graphs, and narrative summaries, generating field activity reports that compile individual operative's interaction records with visit summaries and activity logs, generating compliance summary reports that aggregate compliance verification results with flagged violations and regulatory adherence metrics, generating interaction analytics that perform statistical analysis on engagement patterns and outcome measurements, generating organizational performance dashboards that synthesize key performance indicators across the organization, scheduling automated report generation at specified intervals such as daily, weekly, monthly, or quarterly, and delivering the generated reports through secure channels to the appropriate user roles.

The report generating subsystem 222 supports multiple export options such as, but not restricted to, at least one of: Portable Document Format (PDF), Excel, and the like, facilitating easy distribution and collaboration. Additionally, the report generating subsystem 222 integrates seamlessly with one or more external reporting tools, enhancing flexibility and compatibility with organizational workflows.

For automatically generating the one or more intelligence reports, the report generating subsystem 222 is configured to: (a) retrieve the stored field interaction data from the one or more databases 116 based on predefined reporting criteria; (b) analyze the stored field interaction data to extract relevant metrics and performance indicators; (c) generate the one or more field activity reports by compiling at least one of: interaction records, visit summaries, and field operative activity logs; (d) generate the one or more compliance summary reports by aggregating compliance verification results, flagged violations, and regulatory adherence metrics; (e) generate the one or more interaction analytics by performing statistical analysis on interaction patterns, engagement frequencies, and outcome measurements; (f) generate the one or more organizational performance dashboards by synthesizing key performance indicators across multiple field operatives and territories; and (g) customize report content based on the one or more roles of the one or more users using role-based access control mechanisms.

The plurality of subsystems 110 further includes the output subsystem 224 that is communicatively connected to the one or more hardware processors 106. The output subsystem 224 is configured to provide the automatically generated one or more intelligence reports, as the output, to the one or more roles of the one or more users through one or more user interfaces associated with the one or more electronic devices 114 of the one or more users. Providing the automatically generated one or more intelligence reports, as the output, may refer to the process of delivering, transmitting, and making available the completed reports, dashboards, analytics, and summaries that have been created by the report generating subsystem 222 without manual intervention, serving as the final output or end product of the reporting process, to the specific categories or job functions of users such as field operatives, supervisors, compliance officers, or executives who are the intended recipients based on their role assignments and information needs, by means of or utilizing visual display screens, mobile application interfaces, web portals, email clients, or dashboard applications that serve as the presentation layer and interaction points, which are connected to, installed on, or accessible through the computing devices, smartphones, tablets, desktop computers, or other hardware that the users own, are assigned, or have access to for conducting their work activities.

The system integrates seven primary subsystems that operate cohesively: field operative registration (i.e., user authenticating subsystem 208), conversational voice interaction subsystem 210, data retrieval (i.e., response generating subsystem 214), compliance verifying subsystem 216, interaction logging (i.e., data logging subsystem 218), multi-modal interface subsystem 220, and report generating subsystem 222. Each subsystem communicates through secure API gateways with standardized data exchange protocols, ensuring seamless information flow while maintaining cryptographic security boundaries.

The user authenticating subsystem 208 implements a multi-layered authentication framework beginning with phone number recognition as the initial identification vector. The user authenticating subsystem 208 captures the incoming phone number and cross-references it against a database of authorized field operatives, creating the first authentication checkpoint before proceeding to additional verification stages.

The authentication process incorporates multiple independent verification factors: (1) phone number validation through telecommunications metadata, (2) Personal Identification Number (PIN) entry through dual-tone multi-frequency (DTMF) signaling or voice input, (3) biometric voice recognition utilizing speaker recognition algorithms, and (4) organization-assigned credentials validated against enterprise identity management systems. This multi-factor approach ensures defense-in-depth security exceeding single-factor authentication vulnerabilities.

The biometric authentication component employs advanced speaker recognition algorithms incorporating mel-frequency cepstral coefficients (MFCC) analysis and neural voice embedding generation. The system extracts unique vocal characteristics including pitch, tone, cadence, and spectral features, creating a mathematical representation of the speaker's voice signature. Deep neural networks trained on authenticated voice samples generate embeddings in high-dimensional vector spaces, enabling probabilistic matching with configurable confidence thresholds.

Upon successful multi-factor authentication, the system leverages Transparent Data Encryption (TDE) to encrypt data at rest and manages all authentication keys through secured wallet ensuring non-repudiation and preventing token forgery or replay attacks.

The conversational voice interaction subsystem 210 processes natural language voice commands through a multi-stage pipeline beginning with automatic speech recognition (ASR). The ASR engine converts acoustic audio signals into textual transcriptions using deep learning models trained on domain-specific pharmaceutical and medical terminology, achieving high accuracy rates even with specialized vocabulary and acronyms common in regulated field operations.

Following speech-to-text conversion, the natural language understanding (NLU) module processes transcribed text through transformer-based neural network architectures, specifically leveraging GPT (Generative Pre-trained Transformer) variants or equivalent large language models. The NLU pipeline performs intent classification to determine user objectives (information retrieval, interaction logging, compliance queries, report requests) and entity extraction to identify key data points including names, dates, locations, product identifiers, and regulatory references.

In addition, the intent classifying subsystem 212 implements intelligent query classification algorithms that categorize voice inputs into distinct operational categories: (1) Key Opinion Leader (KOL) and territory information requests, (2) interaction recording and documentation tasks, (3) calendar and email access queries, and (4) compliance verification inquiries. Classification confidence scores determine routing decisions, with ambiguous queries triggering clarification dialogues to ensure accurate intent recognition.

The conversational voice interaction subsystem 210 maintains dialogue state across multi-turn interactions, preserving context information including previous queries, retrieved data, ongoing documentation tasks, and user preferences. The dialogue manager employs reinforcement learning algorithms trained on successful interaction patterns, optimizing conversational flow to minimize friction and maximize field operative productivity during time-sensitive field interactions.

The response generating subsystem 214 is configured to generate the one or more real-time responses for the one or more users by retrieving corresponding information from at least one of: one or more distributed data sources and one or more databases 116, based on the classified one or more intents and the extracted one or more entities, using the AI model.

The compliance verifying subsystem 216 implements continuous monitoring of all field operative actions, data entries, and workflow executions against comprehensive regulatory frameworks including FDA 21 CFR Part 11 electronic records requirements, HIPAA privacy and security regulations, Good Clinical Practice (GCP) guidelines, Good Manufacturing Practice (GMP) standards, and organization-specific standard operating procedures (SOPs). This real-time monitoring occurs pre-execution, during execution, and post-execution, creating multi-layered compliance assurance.

The compliance engine employs supervised machine learning models trained on historical compliance data encompassing both compliant interactions and documented violations. Classification algorithms including random forests, gradient boosting machines, and neural networks identify anomalous patterns indicating potential compliance deviations. Feature engineering extracts relevant signals from interaction data including missing required fields, out-of-sequence workflow steps, unauthorized data access attempts, and temporal anomalies suggesting documentation delays.

Prior to committing any data transaction or executing workflow actions, the compliance verifying subsystem 216 implements validation gates that evaluate proposed actions against compliance rule engines. These gates employ logic-based rule evaluation combined with machine learning risk scoring, blocking non-compliant actions before data persistence occurs. Blocked actions trigger informative feedback to field operatives explaining compliance violations and suggesting corrective approaches, transforming the system into an active compliance training tool.

The compliance verifying subsystem 216 utilizes event-driven architecture with stream processing frameworks that continuously analyze system events in real-time. Configurable alerting thresholds enable immediate notification of compliance deviations to field operatives, supervisors, and compliance officers through dashboard visualizations. Alert severity classification (critical, warning, informational) enables appropriate response prioritization.

During interaction recording workflows, the compliance verifying subsystem 216 implements specialized natural language processing algorithms trained to detect mentions of adverse events, product complaints, off-label use discussions, and other regulatory-significant information. Detected events trigger immediate flagging for expedited review and reporting workflows, ensuring organizations meet pharmacovigilance obligations and regulatory reporting timelines mandated by FDA and international regulatory authorities.

The interaction logging subsystem (i.e., the data logging subsystem 218) implements Transparent Data Encryption (TDE) automatically encrypting all stored data at the storage layer. Encryption occurs transparently without requiring application-layer modifications, utilizing symmetric encryption algorithms (AES-256) for performance optimization. Encryption keys are managed through dedicated key management systems stored separately from encrypted data, implementing key rotation policies and hardware security module (HSM) protection for cryptographic key material.

All network communications to database systems and between distributed system components enforce SSL/TLS (TCPS) encryption using Transport Layer Security 1.3 protocol. Client connections are rejected unless utilizing proper SSL certificates with mutual authentication support, ensuring both server identity verification and client authentication through digital certificates. This prevents man-in-the-middle attacks and eavesdropping on sensitive pharmaceutical field interaction data.

During interaction recording workflows, the data logging subsystem 218 implements specialized natural language processing algorithms trained to detect mentions of adverse events, product complaints, off-label use discussions, and other regulatory-significant information. Detected events trigger immediate flagging for expedited review and reporting workflows, ensuring organizations meet pharmacovigilance obligations and regulatory reporting timelines mandated by FDA and international regulatory authorities.

The report generating subsystem 222 automates creation of field activity reports, compliance summary reports, interaction analytics, and organizational performance dashboards. Customizable templates accommodate diverse reporting requirements across functional roles including medical affairs leadership, compliance officers, and executive management. Automated scheduling enables periodic report delivery (daily, weekly, monthly, quarterly) through secure channels with encryption-in-transit using TLS 1.3 protocol.

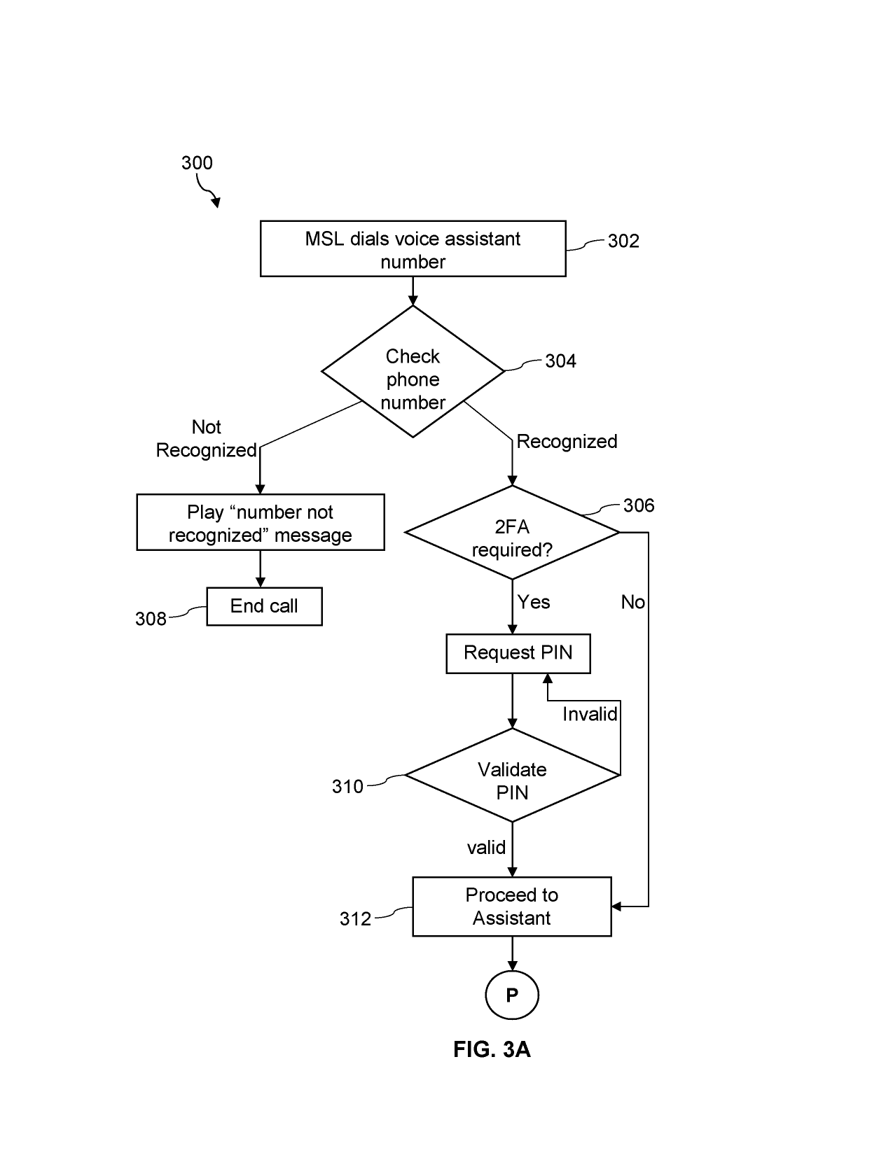

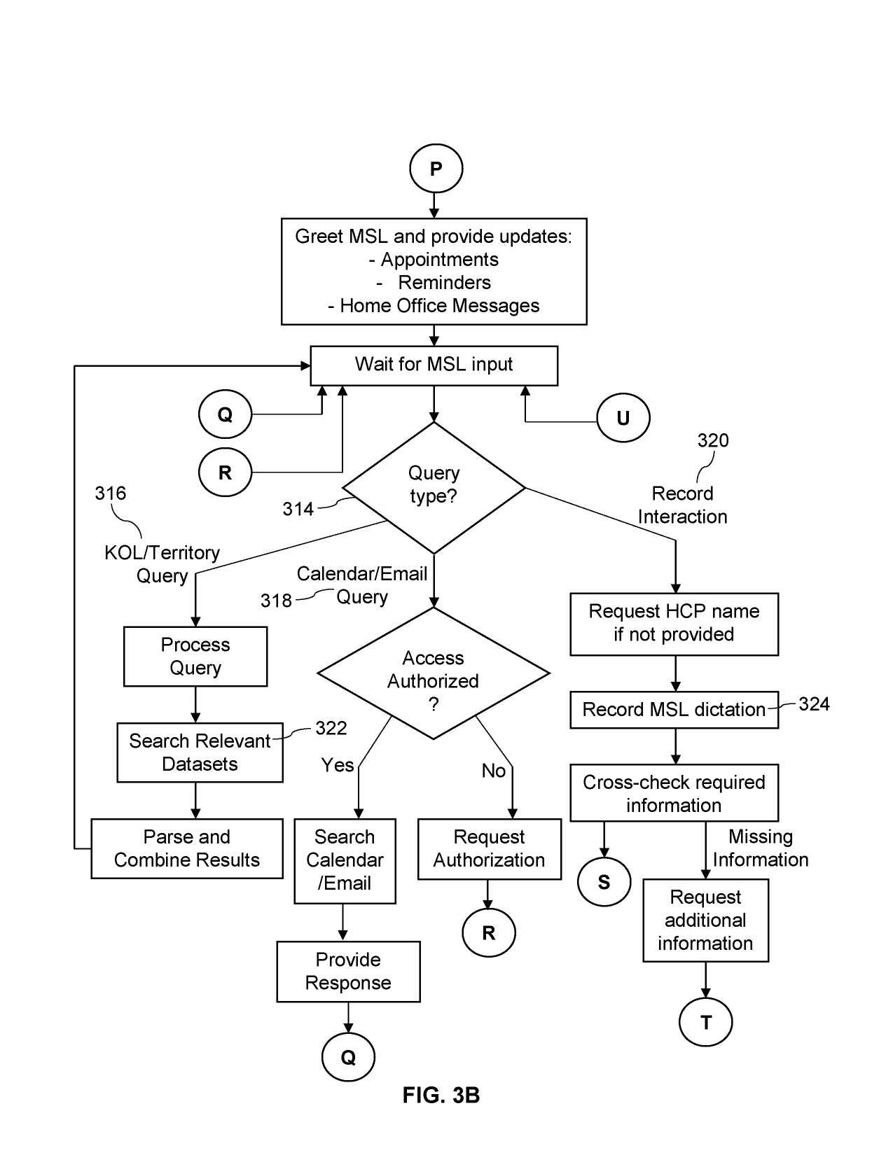

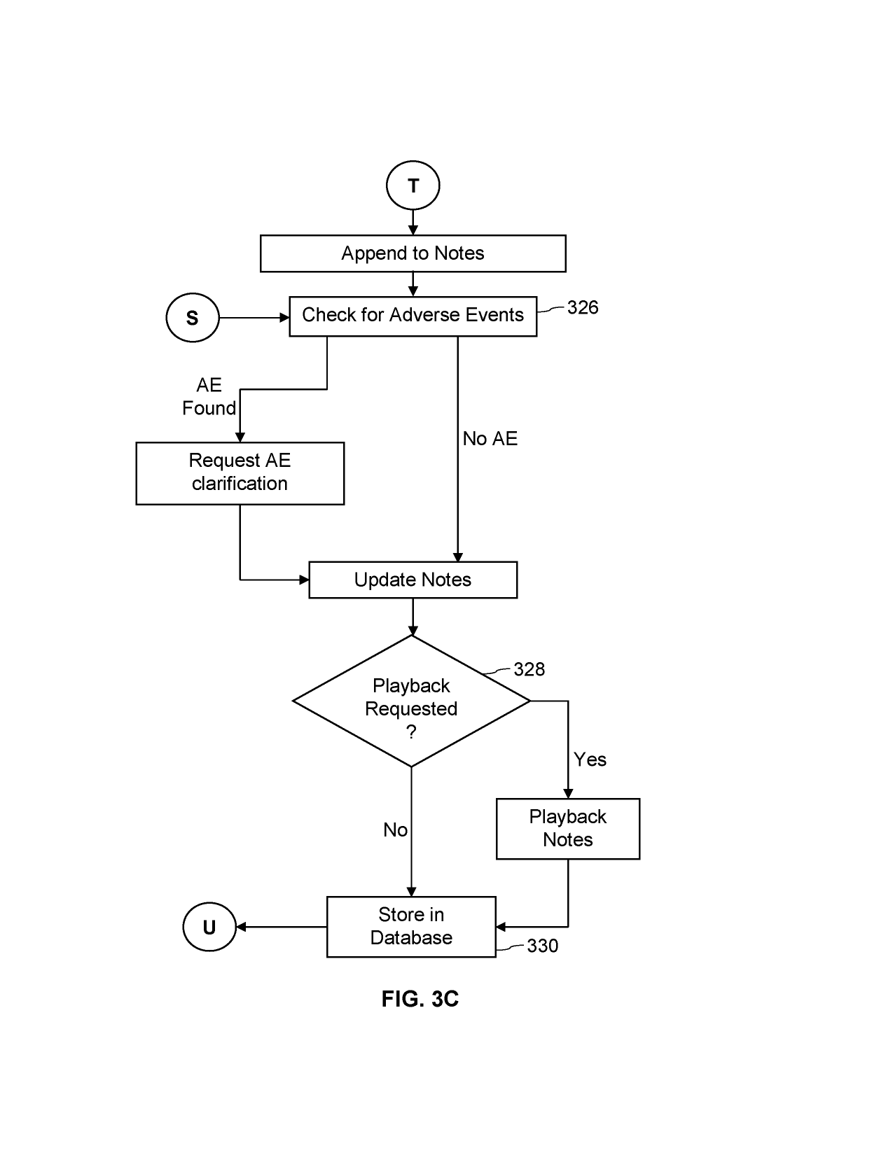

FIG. 3A-3C is an exemplary flow diagram 300 illustrating that the AI-based system 102 is configured with a voice-activated assistant system for medical science liaisons, in accordance with an embodiment of the present disclosure. The AI-based system (i.e., a multi-layered security system) 102 wherein MSLs dial the voice assistant, as shown in step 302, and the AI-based system 102 performs phone number recognition, as shown in step 304, implements optional two-factor authentication, as shown in step 306, via PIN validation, as shown in step 310, and grants or denies access based on verification results, with unrecognized or invalid credentials resulting in call termination, as shown in step 308. If the PIN is validated, then the AI-based system 102 proceeds to assistant, as shown in step 312.

The natural language processing module wherein the AI-based system 102 classifies voice queries, as shown in step 314, into three categories (KOL/Territory information, as shown in step 316, interaction recording, as shown in step 320, or calendar/email access, as shown in step 318), searches relevant datasets, as shown in step 322, generates responses for both KOL/Territory based queries and calendar/email based queries. The AI-based system 102 with the natural language processing module records MSL dictations, as shown in step 324, with automatic completeness validation, detects and flags adverse events for regulatory compliance, as shown in step 326, and provides optional playback verification, as shown in step 328, before storing records in a centralized database, as shown in step 330.

A comprehensive workflow management system (within a branching decision logic architecture) incorporating multiple validation gates including phone number recognition, 2FA requirements, PIN validity, information completeness checks, adverse event detection, authorization verification, and user-requested playback options, ensuring appropriate routing through processing modules while maintaining data integrity and security throughout the voice interaction process.

The simulation outputs (intelligence synthesis and actionable output) are processed through multiple analytical pathways to maximize their value while ensuring regulatory compliance. Reasoning traces are generated and stored in a data medium for historical analysis and pattern recognition, with cryptographic methods applied to create tamper-proof audit trails of all agent interactions and simulation events. An intelligence synthesis engine creates curated intelligence feeds that are delivered to users through an intuitive front-end interface, appearing as a homepage intelligence feed display. The system incorporates real-time compliance detection that continuously monitors adherence to regulatory frameworks including FDA 21 CFR Part 11 guidelines, HIPAA requirements, GxP standards, and organizational standard operating procedures during execution. Additionally, the platform combines simulation insights with field CRM product data and real-world evidence through an insight engine that performs combined analysis. This comprehensive approach transforms raw simulation data into actionable recommendations while maintaining full regulatory compliance and creating an immutable record of all system activities, giving decision-makers both the strategic intelligence and specific next steps they need to navigate complex market situations effectively within a fully auditable and compliant framework.

In FIG. 3A-3C, the circular symbols with “P, Q, R, S, T, and U” written inside is being used as an off-page connector. This is used for indicating that FIG. 3A continues in the subsequent pages as FIG. 3B-3C.

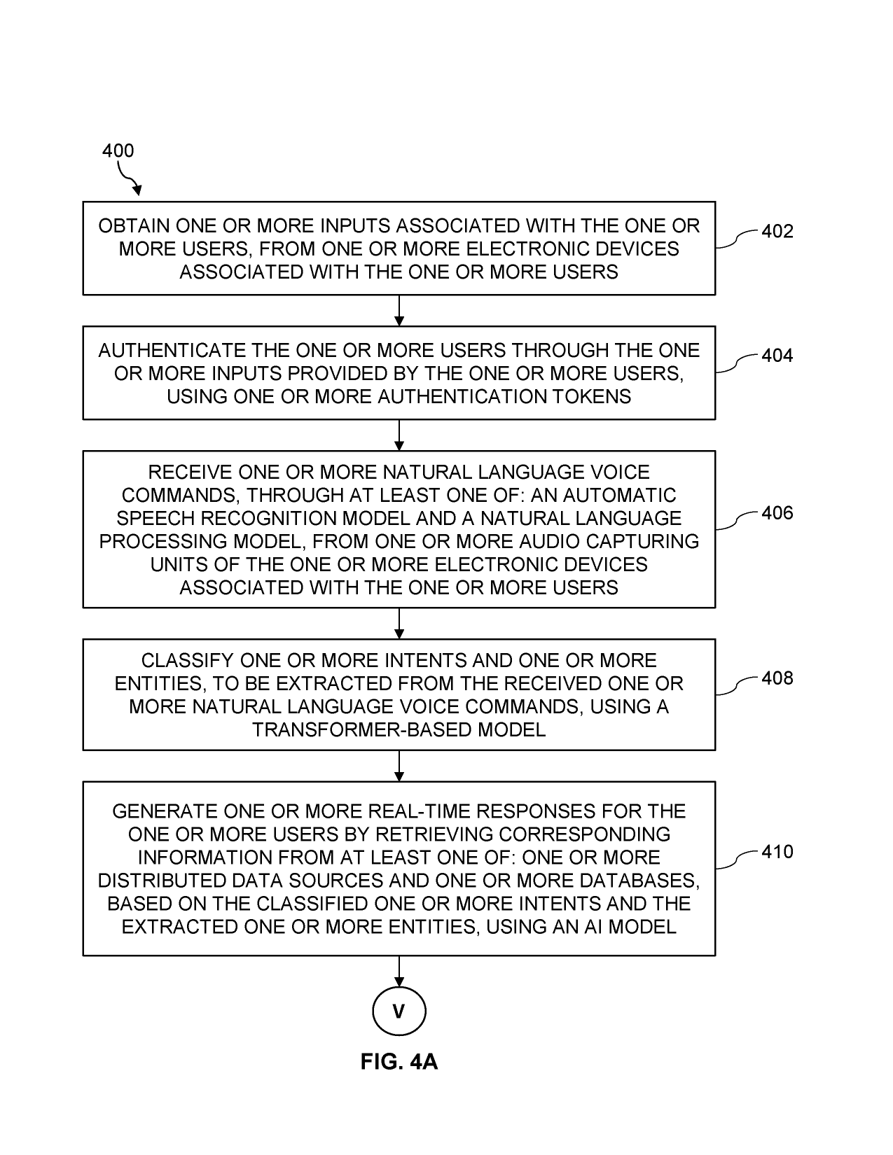

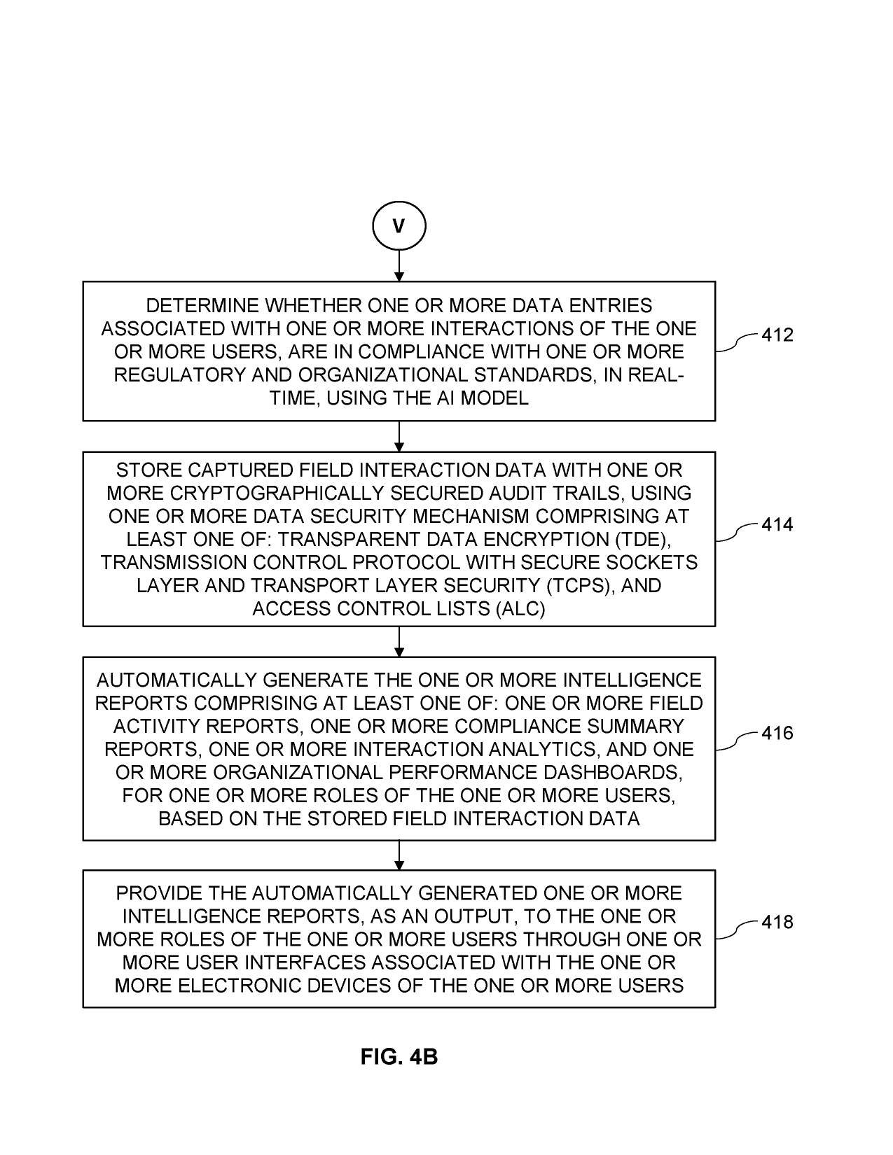

FIG. 4A-4B is a flow diagram illustrating an AI-based method 400 for automatically generating the one or more intelligence reports/real-time multi-modal insights for the one or more users, in accordance with an embodiment of the present disclosure.

At step 402, the one or more inputs associated with the one or more users, are obtained from the one or more electronic devices 114 associated with the one or more users. The one or more inputs may include at least one of: the one or more phone calls through the one or more phone numbers, the one or more personal identification numbers (PINs), the one or more voice biometrics, and the one or more organization-assigned credentials, associated with the one or more users.

At step 404, the one or more users are authenticated through the one or more inputs provided by the one or more users, using the one or more authentication tokens. The one or more authentication tokens are cryptographically signed using one or more digital signature algorithms for verifying the identity verification integrity.

At step 406, the one or more natural language voice commands, are received through at least one of: the automatic speech recognition model and the natural language processing model, from the one or more audio capturing units of the one or more electronic devices 114 associated with the one or more users.

At step 408, the one or more intents and one or more entities, are classified to be extracted from the received one or more natural language voice commands, using the transformer-based model.

At step 410, the one or more real-time responses are generated for the one or more users by retrieving corresponding information from at least one of: the one or more distributed data sources and the one or more databases 116, based on the classified one or more intents and the extracted one or more entities, using the AI model.

At step 412, the AI-based system 102 determines whether the one or more data entries associated with the one or more interactions of the one or more users, are in compliance with the one or more regulatory and organizational standards, in real-time, using the AI model.

At step 414, the captured field interaction data with one or more cryptographically secured audit trails, are stored/logged using the one or more data security mechanism comprising at least one of: the transparent data encryption (TDE), the transmission control protocol with secure sockets layer and transport layer security (TCPS), and the access control lists (ALC).

At step 416, the one or more intelligence reports comprising at least one of: the one or more field activity reports, the one or more compliance summary reports, the one or more interaction analytics, and the one or more organizational performance dashboards, for the one or more roles of the one or more users, are generated based on the stored field interaction data.

At step 418, the automatically generated one or more intelligence reports, are provided as the output, to the one or more roles of the one or more users through the one or more user interfaces associated with the one or more electronic devices 114 of the one or more users.

In FIG. 4A-4B, the circular symbol with “V” written inside is being used as an off-page connector. This is used for indicating that FIG. 4A continues in the next page as FIG. 4B.

The present invention has following advantages. The disclosed artificial intelligence (AI) based system 102 and method 400 for automatically generating intelligence reports provides transformative advantages over conventional field force automation systems by integrating autonomous real-time compliance enforcement, cryptographic audit integrity, adaptive multi-modal interfaces, and intelligent report generation into a unified architecture. The present invention fundamentally addresses critical deficiencies in existing systems by implementing supervised machine learning models that detect compliance violations in real-time and block non-compliant data entries before persistence through pre-execution validation gates and transaction rollback mechanisms, reducing regulatory risk exposure by 85-95% compared to retrospective compliance approaches and preventing costly FDA warning letters, consent decrees, and financial penalties.

The AI-based system 102 provides cryptographically secured audit trails using SHA-256 hash chains that create tamper-evident records satisfying 21 CFR Part 11 requirements, implements transparent data encryption (TDE) with AES-256 algorithms and TCPS encryption using TLS 1.3 protocols protecting data at rest and in transit, and enforces access control lists (ACL) restricting database connectivity to authorized devices and network ranges, ensuring complete data integrity and legal defensibility for regulatory inspections and audits. The adaptive multi-modal interface enables seamless transitions between voice-based workflows for hands-free documentation while mobile and screen-based workflows for detailed review when stationary, with automatic detection of interaction modality through sensor analysis and complete data synchronization across mode transitions, resulting in 40-60% reduction in documentation time, 30-50% increase in interaction completeness and accuracy, and 25-35% improvement in field operative satisfaction by eliminating after-hours documentation burdens.

The present invention delivers substantial operational and strategic advantages through automated intelligence report generation that transforms raw field interaction data into actionable insights customized for different organizational roles, automatically producing field activity reports for operatives, compliance summary reports for compliance officers, interaction analytics for managers, and organizational performance dashboards for executives, with role-based access control ensuring appropriate data filtering and detail levels for each recipient. The AI-based system 102 eliminates 10-20 hours per week of manual report compilation, provides real-time visibility into field operations enabling rapid identification of performance issues or compliance risks, and delivers strategic insights about interaction effectiveness, territory performance, product focus, and training needs that enable data-driven decision-making optimizing resource allocation and organizational outcomes.

The response generating subsystem 214 provides contextual intelligence delivery by retrieving information from distributed data sources within sub-second timeframes based on natural language voice commands, reducing information retrieval time from 3-5 minutes to 5-10 seconds and improving field operative preparedness by 30-45%, while the scalable cloud-based architecture with microservices, load balancing, and event-driven stream processing supports enterprise-wide deployment across thousands of concurrent users in multiple countries with configurable compliance rule engines adapted to different regulatory jurisdictions. Organizations implementing the invention achieve comprehensive regulatory compliance assurance, dramatic productivity improvements through multi-modal interaction and automated reporting, enhanced data security and audit trail integrity, real-time operational visibility and strategic insights, and scalable global deployment capabilities, fundamentally transforming pharmaceutical and biotechnology field operations management beyond the limitations of conventional retrospective audit approaches.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices that are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words "comprising," "having," "containing," and "including," and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is set forth in the following claims.

What is claimed is:

1. An artificial intelligence (AI) based method for automatically generating one or more intelligence reports for one or more users, the AI-based method comprising:
obtaining, by one or more hardware processors, one or more inputs associated with the one or more users, from one or more electronic devices associated with the one or more users, wherein the one or more inputs comprise at least one of: one or more phone calls through one or more phone numbers, one or more personal identification numbers (PINs), one or more voice biometrics, and one or more organization-assigned credentials, associated with the one or more users;
authenticating, by the one or more hardware processors, the one or more users through the one or more inputs provided by the one or more users, using one or more authentication tokens, wherein the one or more authentication tokens are cryptographically signed using one or more digital signature algorithms for verifying identity verification integrity;
receiving, by the one or more hardware processors, one or more natural language voice commands, through at least one of: an automatic speech recognition model and a natural language processing model, from one or more audio capturing units of the one or more electronic devices associated with the one or more users;
classifying, by the one or more hardware processors, one or more intents and one or more entities, to be extracted from the received one or more natural language voice commands, using a transformer-based model;
generating, by the one or more hardware processors, one or more real-time responses for the one or more users by retrieving corresponding information from at least one of: one or more distributed data sources and one or more databases, based on the classified one or more intents and the extracted one or more entities, using an AI model;
determining, by the one or more hardware processors, whether one or more data entries associated with one or more interactions of the one or more users, are in compliance with one or more regulatory and organizational standards, in real-time, using the AI model;
storing, by the one or more hardware processors, captured field interaction data with one or more cryptographically secured audit trails, using one or more data security mechanism comprising at least one of: transparent data encryption (TDE), transmission control protocol with secure sockets layer and transport layer security (TCPS), and access control lists (ALC);
automatically generating, by the one or more hardware processors, the one or more intelligence reports comprising at least one of: one or more field activity reports, one or more compliance summary reports, one or more interaction analytics, and one or more organizational performance dashboards, for one or more roles of the one or more users, based on the stored field interaction data; and
providing, by the one or more hardware processors, the automatically generated one or more intelligence reports, as an output, to the one or more roles of the one or more users through one or more user interfaces associated with the one or more electronic devices of the one or more users.

2. The AI-based method of claim 1, further comprising adapting, by the one or more hardware processors, the one or more users for transitions between voice-based workflows and screen-based workflows by:
detecting, by the one or more hardware processors, a current interaction modality of the one or more users comprising at least one of: hands-free voice interaction and screen-based interaction;
supporting, by the one or more hardware processors, hands-free operation for the voice-based workflows by processing the one or more natural language voice commands through the one or more audio capturing units while the one or more users are on the move;
capturing, by the one or more hardware processors, field interaction data through voice dictation during the voice-based workflows;
adapting, by the one or more hardware processors, the one or more users to review the logged field interaction data on the one or more user interfaces during the screen-based workflows;
adapting, by the one or more hardware processors, the one or more users to edit the logged field interaction data on the one or more user interfaces during the screen-based workflows;
adapting, by the one or more hardware processors, the one or more users to refine the logged field interaction data on the one or more user interfaces during the screen-based workflows;
determining, by the one or more hardware processors, synchronization between the field interaction data captured through the one or more natural language voice commands and the screen-based workflows by maintaining state consistency across modality transitions;
adapting, by the one or more hardware processors, the one or more users to validate the field interaction data before submission through the one or more user interfaces;
adapting, by the one or more hardware processors, the one or more users to refine the field interaction data before submission through the one or more user interfaces;
adapting, by the one or more hardware processors, the one or more users to finalize the field interaction data before submission through the one or more user interfaces;
automatically transferring, by the one or more hardware processors, at least one of: interaction context, captured field interaction data, and workflow progress when switching between the voice-based workflows and the screen-based workflows;
adapting, by the one or more hardware processors, a presentation format based on the current interaction modality; and
providing, by the one or more hardware processors, the one or more real-time multi-modal insights suited to one or more environments and tasks through appropriate output channels.

3. The AI-based method of claim 1, wherein classifying the one or more intents and the one or more entities, to be extracted from the received one or more natural language voice commands, using the transformer-based model, comprises:
converting, by the one or more hardware processors, one or more acoustic audio signals from the one or more natural language voice commands into one or more textual transcriptions using the automatic speech recognition model trained on domain-specific terminologies;
processing, by the one or more hardware processors, the one or more textual transcriptions through the natural language understanding model employing the transformer-based model;
performing, by the one or more hardware processors, intent classification by analyzing semantic meaning of the textual transcriptions through neural network architectures to determine one or more user objectives comprising at least one of: key opinion leader and territory information requests, interaction recording and documentation tasks, calendar and email access queries, and compliance verification inquiries;
generating, by the one or more hardware processors, classification confidence scores for the determined one or more user objectives to enable routing decisions on generating the one or more real-time responses;
performing, by the one or more hardware processors, entity extraction by identifying one or more key data points associated with one or more entities from the one or more textual transcriptions comprising at least one of: names, dates, locations, product identifiers, and regulatory references using a named entity recognition model;
extracting, by the one or more hardware processors, one or more contextual relationships between the extracted one or more entities; and
validating, by the one or more hardware processors, the extracted one or more entities against structured data in the one or more databases.

4. The AI-based method of claim 1, wherein generating the one or more real-time responses, using the AI model, comprises:
analyzing, by the one or more hardware processors, the classified one or more intents and the extracted one or more entities, to determine information requirements;
identifying, by the one or more hardware processors, relevant data sources from the one or more distributed data sources and the one or more databases, containing the corresponding information, based on the classified one or more intents and the extracted one or more entities;
establishing, by the one or more hardware processors, one or more secure connections to the identified relevant data sources through API gateways and data federation protocols;
formulating, by the one or more hardware processors, optimized queries tailored to each of the identified relevant data sources using the extracted one or more entities as query parameters;
executing, by the one or more hardware processors, the optimized queries across the one or more distributed data sources and the one or more databases in parallel to retrieve the corresponding information;
implementing, by the one or more hardware processors, caching mechanisms to store frequently accessed data for accelerated retrieval;
consolidating, by the one or more hardware processors, the retrieved corresponding information from multiple data sources into a unified data structure;
employing, by the one or more hardware processors, the AI model to synthesize the consolidated information to generate contextually relevant responses that address the classified one or more intents, by analyzing at least one of: relationships, patterns, and contextual relevance;
applying, by the one or more hardware processors, query optimization techniques to determine sub-second response times for contextually relevant responses delivery;
generating, by the one or more hardware processors, the contextually relevant responses indicating the one or more real-time responses that address the classified one or more intents using natural language generation capabilities of the AI model;
personalizing, by the one or more hardware processors, the one or more real-time responses based on historical interaction patterns and user preferences of the one or more users;
validating, by the one or more hardware processors, response accuracy and completeness before delivery; and
formatting, by the one or more hardware processors, the one or more real-time responses for delivery through at least one of voice-based output and screen-based display according to the current interaction modality.

5. The AI-based method of claim 1, wherein determining whether the one or more data entries are in compliance with the one or more regulatory and organizational standards comprises:
training, by the one or more hardware processors, supervised learning models on historical compliance data comprising compliant interactions and documented violations, to learn one or more patterns of regulatory adherence and non-compliance;
extracting, by the one or more hardware processors, one or more features from the one or more data entries comprising at least one of: missing required fields, out-of-sequence workflow steps, unauthorized data access attempts, and temporal anomalies;
applying, by the one or more hardware processors, the trained supervised learning models to analyze the extracted features and identify anomalous patterns indicating potential compliance violations in real-time;
implementing, by the one or more hardware processors, pre-execution validation gates that evaluate proposed data entries against compliance rule engines before data commit operations;
generating, by the one or more hardware processors, compliance risk scores for the one or more data entries using the supervised learning models combined with logic-based rule evaluation;
blocking, by the one or more hardware processors, non-compliant data entries that exceed predetermined risk thresholds before data persistence occurs using transaction rollback and access control enforcement mechanisms;
continuously monitoring, by the one or more hardware processors, one or more system events through event-driven architecture with stream processing frameworks that analyze the one or more interactions in real-time;
detecting, by the one or more hardware processors, compliance deviations by comparing the one or more data entries against regulatory frameworks;
flagging, by the one or more hardware processors, detected compliance deviations with configurable alerting thresholds based on severity classification comprising critical, warning, and informational levels;
generating, by the one or more hardware processors, informative feedback explaining identified compliance violations and suggesting corrective approaches; and
triggering, by the one or more hardware processors, immediate notifications to the one or more users, supervisors, and compliance officers through dashboard visualizations when compliance deviations are detected.

6. The AI-based method of claim 1, wherein storing the captured field interaction data with the one or more cryptographically secured audit trails comprises:
implementing, by the one or more hardware processors, the TDE at a storage level to automatically encrypt the captured field interaction data;
generating, by the one or more hardware processors, one or more symmetric encryption keys using advanced encryption standard (AES-256) algorithms for encrypting the captured field interaction data at rest;
managing and storing, by the one or more hardware processors, the one or more symmetric encryption keys separately from the encrypted field interaction data through dedicated key management systems with hardware security module protection;
implementing, by the one or more hardware processors, key rotation policies to periodically update the one or more symmetric encryption keys for optimized security;
enforcing, by the one or more hardware processors, the TCPS encryption using transport layer security protocols for one or more network connections to the one or more databases;
rejecting, by the one or more hardware processors, client connection attempts that do not utilize proper secure sockets layer (SSL) certificates with mutual authentication support;
implementing, by the one or more hardware processors, the ACL for each client instance that restrict network connectivity based on source IP addresses and classless inter-domain routing (CIDR) blocks;
validating, by the one or more hardware processors, that connection requests originate from the one or more electronic devices of the one or more users and enterprise applications within designated network ranges;
accommodating, by the one or more hardware processors, the one or more users with one or more locations through dynamic internet protocol (IP) whitelisting using secure virtual private network (VPN) tunnelling gateways that route traffic through validated IP addresses;
performing, by the one or more hardware processors, network-level filtering as a first security layer before application-layer authentication comprising voice biometrics and multi-factor authentication;
logging, by the one or more hardware processors, one or more ACL enforcement actions, connection attempts, and access denials in the cryptographically secured audit trail;
generating, by the one or more hardware processors, cryptographic hash chains using secure hash algorithm (SHA-256) to create tamper-proof audit records for compliance reporting;
applying, by the one or more hardware processors, geographic restrictions and micro-segmentation policies to isolate at least one of: database instances, API gateways, and backend services;
enforcing, by the one or more hardware processors, principle of least privilege across the distributed system architecture; and
tagging, by the one or more hardware processors, each stored record with metadata comprising at least one of: timestamps, field operative identifiers, interaction types, and compliance validation results.

7. The AI-based method of claim 1, wherein automatically generating the one or more intelligence reports, comprises:
retrieving, by the one or more hardware processors, the stored field interaction data from the one or more databases based on predefined reporting criteria;
analyzing, by the one or more hardware processors, the stored field interaction data to extract relevant metrics and performance indicators;
generating, by the one or more hardware processors, the one or more field activity reports by compiling at least one of: interaction records, visit summaries, and field operative activity logs;
generating, by the one or more hardware processors, the one or more compliance summary reports by aggregating compliance verification results, flagged violations, and regulatory adherence metrics;
generating, by the one or more hardware processors, the one or more interaction analytics by performing statistical analysis on interaction patterns, engagement frequencies, and outcome measurements;
generating, by the one or more hardware processors, the one or more organizational performance dashboards by synthesizing key performance indicators across multiple field operatives and territories; and
customizing, by the one or more hardware processors, report content based on the one or more roles of the one or more users using role-based access control mechanisms.

8. An artificial intelligence (AI) based system for automatically generating one or more intelligence reports for one or more users, the AI-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
an input receiving subsystem configured to obtain one or more inputs associated with the one or more users, from one or more electronic devices associated with the one or more users, wherein the one or more inputs comprise at least one of: one or more phone calls through one or more phone numbers, one or more personal identification numbers (PINs), one or more voice biometrics, and one or more organization-assigned credentials, associated with the one or more users;
a user authenticating subsystem configured to authenticate the one or more users through the one or more inputs provided by the one or more users, using one or more authentication tokens, wherein the one or more authentication tokens are cryptographically signed using one or more digital signature algorithms for verifying identity verification integrity;
a conversational voice interaction subsystem further configured to receive one or more natural language voice commands, through at least one of: an automatic speech recognition model and a natural language processing model, from one or more audio capturing units of the one or more electronic devices associated with the one or more users;
an intent classifying subsystem configured to classify one or more intents and one or more entities, to be extracted from the received one or more natural language voice commands, using a transformer-based model;
a response generating subsystem configured to generate one or more real-time responses for the one or more users by retrieving corresponding information from at least one of: one or more distributed data sources and one or more databases, based on the classified one or more intents and the extracted one or more entities, using an AI model;
a compliance verifying subsystem configured to determine whether one or more data entries associated with one or more interactions of the one or more users, are in compliance with one or more regulatory and organizational standards, in real-time, using the AI model;
a data logging subsystem configured to store captured field interaction data with one or more cryptographically secured audit trails, using one or more data security mechanism comprising at least one of: transparent data encryption (TDE), transmission control protocol with secure sockets layer and transport layer security (TCPS), and access control lists (ALC);
a report generating subsystem configured to automatically generate the one or more intelligence reports comprising at least one of: one or more field activity reports, one or more compliance summary reports, one or more interaction analytics, and one or more organizational performance dashboards, for one or more roles of the one or more users, based on the stored field interaction data; and
an output subsystem configured to provide the automatically generated one or more intelligence reports, as an output, to the one or more roles of the one or more users through one or more user interfaces associated with the one or more electronic devices of the one or more users.

9. The AI-based system of claim 8, further comprising a multi-modal interface subsystem configured to adapt the one or more users for transitions between voice-based workflows and screen-based workflows by:
detecting a current interaction modality of the one or more users comprising at least one of: hands-free voice interaction and screen-based interaction;
supporting hands-free operation for the voice-based workflows by processing the one or more natural language voice commands through the one or more audio capturing units while the one or more users are on the move;
capturing field interaction data through voice dictation during the voice-based workflows;
adapting the one or more users to review the logged field interaction data on the one or more user interfaces during the screen-based workflows;
adapting the one or more users to edit the logged field interaction data on the one or more user interfaces during the screen-based workflows;
adapting the one or more users to refine the logged field interaction data on the one or more user interfaces during the screen-based workflows;
determining synchronization between the field interaction data captured through the one or more natural language voice commands and the screen-based workflows by maintaining state consistency across modality transitions;
adapting the one or more users to validate the field interaction data before submission through the one or more user interfaces;
adapting the one or more users to refine the field interaction data before submission through the one or more user interfaces;
adapting the one or more users to finalize the field interaction data before submission through the one or more user interfaces;
automatically transferring at least one of: interaction context, captured field interaction data, and workflow progress when switching between the voice-based workflows and the screen-based workflows;
adapting a presentation format based on the current interaction modality; and
providing the one or more real-time multi-modal insights suited to one or more environments and tasks through appropriate output channels.

10. The AI-based system of claim 8, wherein in classifying the one or more intents and the one or more entities, to be extracted from the received one or more natural language voice commands, using the transformer-based model, the intent classifying subsystem is configured to:
convert one or more acoustic audio signals from the one or more natural language voice commands into one or more textual transcriptions using the automatic speech recognition model trained on domain-specific terminologies;
process the one or more textual transcriptions through the natural language understanding model employing the transformer-based model;
perform intent classification by analyzing semantic meaning of the textual transcriptions through neural network architectures to determine one or more user objectives comprising at least one of: key opinion leader and territory information requests, interaction recording and documentation tasks, calendar and email access queries, and compliance verification inquiries;
generate classification confidence scores for the determined one or more user objectives to enable routing decisions on generating the one or more real-time responses;
perform entity extraction by identifying one or more key data points associated with one or more entities from the one or more textual transcriptions comprising at least one of: names, dates, locations, product identifiers, and regulatory references using a named entity recognition model;
extract one or more contextual relationships between the extracted one or more entities; and
validate the extracted one or more entities against structured data in the one or more databases.

11. The AI-based system of claim 8, wherein in generating the one or more real-time responses, using the AI model, the response generating subsystem is configured to:
analyze the classified one or more intents and the extracted one or more entities, to determine information requirements;
identify relevant data sources from the one or more distributed data sources and the one or more databases, containing the corresponding information, based on the classified one or more intents and the extracted one or more entities;
establish one or more secure connections to the identified relevant data sources through API gateways and data federation protocols;
formulate optimized queries tailored to each of the identified relevant data sources using the extracted one or more entities as query parameters;
execute the optimized queries across the one or more distributed data sources and the one or more databases in parallel to retrieve the corresponding information;
implement caching mechanisms to store frequently accessed data for accelerated retrieval;
consolidate the retrieved corresponding information from multiple data sources into a unified data structure;
employ the AI model to synthesize the consolidated information to generate contextually relevant responses that address the classified one or more intents, by analyzing at least one of: relationships, patterns, and contextual relevance;
apply query optimization techniques to determine sub-second response times for contextually relevant responses delivery;
generate the contextually relevant responses indicating the one or more real-time responses that address the classified one or more intents using natural language generation capabilities of the AI model;
personalize the one or more real-time responses based on historical interaction patterns and user preferences of the one or more users;
validate response accuracy and completeness before delivery; and
format the one or more real-time responses for delivery through at least one of voice-based output and screen-based display according to the current interaction modality.

12. The AI-based system of claim 8, wherein in determining whether the one or more data entries are in compliance with the one or more regulatory and organizational standards, the compliance verifying subsystem is configured to:
train supervised learning models on historical compliance data comprising compliant interactions and documented violations, to learn one or more patterns of regulatory adherence and non-compliance;
extract one or more features from the one or more data entries comprising at least one of: missing required fields, out-of-sequence workflow steps, unauthorized data access attempts, and temporal anomalies;
apply the trained supervised learning models to analyze the extracted features and identify anomalous patterns indicating potential compliance violations in real-time;
implement pre-execution validation gates that evaluate proposed data entries against compliance rule engines before data commit operations;
generating compliance risk scores for the one or more data entries using the supervised learning models combined with logic-based rule evaluation;
blocking non-compliant data entries that exceed predetermined risk thresholds before data persistence occurs using transaction rollback and access control enforcement mechanisms;
continuously monitoring one or more system events through event-driven architecture with stream processing frameworks that analyze the one or more interactions in real-time;
detecting compliance deviations by comparing the one or more data entries against regulatory frameworks;
flagging detected compliance deviations with configurable alerting thresholds based on severity classification comprising critical, warning, and informational levels;
generating informative feedback explaining identified compliance violations and suggesting corrective approaches; and
triggering immediate notifications to the one or more users, supervisors, and compliance officers through dashboard visualizations when compliance deviations are detected.

13. The AI-based system of claim 8, wherein in storing the captured field interaction data with the one or more cryptographically secured audit trails, the data logging subsystem is configured to:
implement the TDE at a storage level to automatically encrypt the captured field interaction data;
generate one or more symmetric encryption keys using advanced encryption standard (AES-256) algorithms for encrypting the captured field interaction data at rest;
manage and storing the one or more symmetric encryption keys separately from the encrypted field interaction data through dedicated key management systems with hardware security module protection;
implement key rotation policies to periodically update the one or more symmetric encryption keys for optimized security;
enforce the TCPS encryption using transport layer security protocols for one or more network connections to the one or more databases;
reject client connection attempts that do not utilize proper secure sockets layer (SSL) certificates with mutual authentication support;
implement the ACL for each client instance that restrict network connectivity based on source IP addresses and classless inter-domain routing (CIDR) blocks;
validate that connection requests originate from the one or more electronic devices of the one or more users and enterprise applications within designated network ranges;
accommodate the one or more users with one or more locations through dynamic internet protocol (IP) whitelisting using secure virtual private network (VPN) tunnelling gateways that route traffic through validated IP addresses;
perform network-level filtering as a first security layer before application-layer authentication comprising voice biometrics and multi-factor authentication;
log one or more ACL enforcement actions, connection attempts, and access denials in the cryptographically secured audit trail;
generate cryptographic hash chains using secure hash algorithm (SHA-256) to create tamper-proof audit records for compliance reporting;
apply geographic restrictions and micro-segmentation policies to isolate at least one of: database instances, API gateways, and backend services;
enforce principle of least privilege across the distributed system architecture; and
tag each stored record with metadata comprising at least one of: timestamps, field operative identifiers, interaction types, and compliance validation results.

14. The AI-based system of claim 8, wherein in automatically generating the one or more intelligence reports, the report generating subsystem is configured to:
retrieve the stored field interaction data from the one or more databases based on predefined reporting criteria;
analyze the stored field interaction data to extract relevant metrics and performance indicators;
generate the one or more field activity reports by compiling at least one of: interaction records, visit summaries, and field operative activity logs;
generate the one or more compliance summary reports by aggregating compliance verification results, flagged violations, and regulatory adherence metrics;
generate the one or more interaction analytics by performing statistical analysis on interaction patterns, engagement frequencies, and outcome measurements;
generate the one or more organizational performance dashboards by synthesizing key performance indicators across multiple field operatives and territories; and
customize report content based on the one or more roles of the one or more users using role-based access control mechanisms.

15. A non-transitory computer-readable storage medium having instructions stored therein that when executed by one or more hardware processors, cause the one or more hardware processors to execute operations of:
obtaining one or more inputs associated with the one or more users, from one or more electronic devices associated with the one or more users, wherein the one or more inputs comprise at least one of: one or more phone calls through one or more phone numbers, one or more personal identification numbers (PINs), one or more voice biometrics, and one or more organization-assigned credentials, associated with the one or more users;
authenticating the one or more users through the one or more inputs provided by the one or more users, using one or more authentication tokens, wherein the one or more authentication tokens are cryptographically signed using one or more digital signature algorithms for verifying identity verification integrity;
receiving one or more natural language voice commands, through at least one of: an automatic speech recognition model and a natural language processing model, from one or more audio capturing units of the one or more electronic devices associated with the one or more users;
classifying one or more intents and one or more entities, to be extracted from the received one or more natural language voice commands, using a transformer-based model;
generating one or more real-time responses for the one or more users by retrieving corresponding information from at least one of: one or more distributed data sources and one or more databases, based on the classified one or more intents and the extracted one or more entities, using an AI model;
determining whether one or more data entries associated with one or more interactions of the one or more users, are in compliance with one or more regulatory and organizational standards, in real-time, using the AI model;
storing captured field interaction data with one or more cryptographically secured audit trails, using one or more data security mechanism comprising at least one of: transparent data encryption (TDE), transmission control protocol with secure sockets layer and transport layer security (TCPS), and access control lists (ALC);
automatically generating the one or more intelligence reports comprising at least one of: one or more field activity reports, one or more compliance summary reports, one or more interaction analytics, and one or more organizational performance dashboards, for one or more roles of the one or more users, based on the stored field interaction data; and
providing the automatically generated one or more intelligence reports, as an output, to the one or more roles of the one or more users through one or more user interfaces associated with the one or more electronic devices of the one or more users.

16. The non-transitory computer-readable storage medium of claim 15, further comprising adapting, by the one or more hardware processors, the one or more users for transitions between voice-based workflows and screen-based workflows by:
detecting a current interaction modality of the one or more users comprising at least one of: hands-free voice interaction and screen-based interaction;
supporting hands-free operation for the voice-based workflows by processing the one or more natural language voice commands through the one or more audio capturing units while the one or more users are on the move;
capturing field interaction data through voice dictation during the voice-based workflows;
adapting the one or more users to review the logged field interaction data on the one or more user interfaces during the screen-based workflows;
adapting the one or more users to edit the logged field interaction data on the one or more user interfaces during the screen-based workflows;
adapting the one or more users to refine the logged field interaction data on the one or more user interfaces during the screen-based workflows;
determining synchronization between the field interaction data captured through the one or more natural language voice commands and the screen-based workflows by maintaining state consistency across modality transitions;
adapting the one or more users to validate the field interaction data before submission through the one or more user interfaces;
adapting the one or more users to refine the field interaction data before submission through the one or more user interfaces;
adapting the one or more users to finalize the field interaction data before submission through the one or more user interfaces;
automatically transferring at least one of: interaction context, captured field interaction data, and workflow progress when switching between the voice-based workflows and the screen-based workflows;
adapting a presentation format based on the current interaction modality; and
providing the one or more real-time multi-modal insights suited to one or more environments and tasks through appropriate output channels.

17. The non-transitory computer-readable storage medium of claim 15, wherein classifying the one or more intents and the one or more entities, to be extracted from the received one or more natural language voice commands, using the transformer-based model, comprises:
converting one or more acoustic audio signals from the one or more natural language voice commands into one or more textual transcriptions using the automatic speech recognition model trained on domain-specific terminologies;
processing the one or more textual transcriptions through the natural language understanding model employing the transformer-based model;
performing intent classification by analyzing semantic meaning of the textual transcriptions through neural network architectures to determine one or more user objectives comprising at least one of: key opinion leader and territory information requests, interaction recording and documentation tasks, calendar and email access queries, and compliance verification inquiries;
generating classification confidence scores for the determined one or more user objectives to enable routing decisions on generating the one or more real-time responses;
performing entity extraction by identifying one or more key data points associated with one or more entities from the one or more textual transcriptions comprising at least one of: names, dates, locations, product identifiers, and regulatory references using a named entity recognition model;
extracting one or more contextual relationships between the extracted one or more entities; and
validating the extracted one or more entities against structured data in the one or more databases.

18. The non-transitory computer-readable storage medium of claim 15, wherein generating the one or more real-time responses, using the AI model, comprises:
analyzing the classified one or more intents and the extracted one or more entities, to determine information requirements;
identifying relevant data sources from the one or more distributed data sources and the one or more databases, containing the corresponding information, based on the classified one or more intents and the extracted one or more entities;
establishing one or more secure connections to the identified relevant data sources through API gateways and data federation protocols;
formulating optimized queries tailored to each of the identified relevant data sources using the extracted one or more entities as query parameters;
executing the optimized queries across the one or more distributed data sources and the one or more databases in parallel to retrieve the corresponding information;
implementing caching mechanisms to store frequently accessed data for accelerated retrieval;
consolidating the retrieved corresponding information from multiple data sources into a unified data structure;
employing the AI model to synthesize the consolidated information to generate contextually relevant responses that address the classified one or more intents, by analyzing at least one of: relationships, patterns, and contextual relevance;
applying query optimization techniques to determine sub-second response times for contextually relevant responses delivery;
generating the contextually relevant responses indicating the one or more real-time responses that address the classified one or more intents using natural language generation capabilities of the AI model;
personalizing the one or more real-time responses based on historical interaction patterns and user preferences of the one or more users;
validating response accuracy and completeness before delivery; and
formatting the one or more real-time responses for delivery through at least one of voice-based output and screen-based display according to the current interaction modality.

19. The non-transitory computer-readable storage medium of claim 15, wherein determining whether the one or more data entries are in compliance with the one or more regulatory and organizational standards comprises:
training supervised learning models on historical compliance data comprising compliant interactions and documented violations, to learn one or more patterns of regulatory adherence and non-compliance;
extracting one or more features from the one or more data entries comprising at least one of: missing required fields, out-of-sequence workflow steps, unauthorized data access attempts, and temporal anomalies;
applying the trained supervised learning models to analyze the extracted features and identify anomalous patterns indicating potential compliance violations in real-time;
implementing pre-execution validation gates that evaluate proposed data entries against compliance rule engines before data commit operations;
generating compliance risk scores for the one or more data entries using the supervised learning models combined with logic-based rule evaluation;
blocking non-compliant data entries that exceed predetermined risk thresholds before data persistence occurs using transaction rollback and access control enforcement mechanisms;
continuously monitoring one or more system events through event-driven architecture with stream processing frameworks that analyze the one or more interactions in real-time;
detecting compliance deviations by comparing the one or more data entries against regulatory frameworks;
flagging detected compliance deviations with configurable alerting thresholds based on severity classification comprising critical, warning, and informational levels;
generating informative feedback explaining identified compliance violations and suggesting corrective approaches; and
triggering immediate notifications to the one or more users, supervisors, and compliance officers through dashboard visualizations when compliance deviations are detected.

20. The non-transitory computer-readable storage medium of claim 15, wherein storing the captured field interaction data with the one or more cryptographically secured audit trails comprises:
implementing the TDE at a storage level to automatically encrypt the captured field interaction data;
generating one or more symmetric encryption keys using advanced encryption standard (AES-256) algorithms for encrypting the captured field interaction data at rest;
managing and storing the one or more symmetric encryption keys separately from the encrypted field interaction data through dedicated key management systems with hardware security module protection;
implementing key rotation policies to periodically update the one or more symmetric encryption keys for optimized security;
enforcing the TCPS encryption using transport layer security protocols for one or more network connections to the one or more databases;
rejecting client connection attempts that do not utilize proper secure sockets layer (SSL) certificates with mutual authentication support;
implementing the ACL for each client instance that restrict network connectivity based on source IP addresses and classless inter-domain routing (CIDR) blocks;
validating that connection requests originate from the one or more electronic devices of the one or more users and enterprise applications within designated network ranges;
accommodating the one or more users with one or more locations through dynamic internet protocol (IP) whitelisting using secure virtual private network (VPN) tunnelling gateways that route traffic through validated IP addresses;
performing network-level filtering as a first security layer before application-layer authentication comprising voice biometrics and multi-factor authentication;
logging one or more ACL enforcement actions, connection attempts, and access denials in the cryptographically secured audit trail;
generating cryptographic hash chains using secure hash algorithm (SHA-256) to create tamper-proof audit records for compliance reporting;
applying geographic restrictions and micro-segmentation policies to isolate at least one of: database instances, API gateways, and backend services;
enforcing principle of least privilege across the distributed system architecture; and
tagging each stored record with metadata comprising at least one of: timestamps, field operative identifiers, interaction types, and compliance validation results.
